(19) United States
(12) Patent Application Publication
(10) Pub. No.: US 2021/0110306 A1
(43) Pub. Date: Apr. 15, 2021

(54) META-TRANSFER LEARNING VIA CONTEXTUAL INVARIANTS FOR CROSS-DOMAIN RECOMMENDATION

(71) Applicant: Visa International Service Association, San Francisco, CA (US)

(72) Inventors: Adit KRISHNAN, Urbana, IL (US); Mahashweta DAS, Sunnyvale, CA (US); Mangesh BENDRE, Sunnyvale, CA (US); Fei WANG, San Francisco, CA (US); Hao YANG, San Jose, CA (US)

(73) Assignee: Visa International Service Association, San Francisco, CA (US)

(21) Appl. No.: 17/070,795

(22) Filed: Oct. 14, 2020

Related U.S. Application Data
(60) Provisional application No. 62/914,644, filed on Oct. 14, 2019.

(51) Int. Cl. G06N 20/00; G06N 5/04

(52) U.S. Cl. CPC G06N 20/00; G06N 5/04

(57) ABSTRACT

Systems, apparatuses, methods, and computer-readable media are provided to alleviate data sparsity in cross-recommendation systems. In particular, some embodiments are directed to a recommendation framework that addresses data sparsity and data scalability challenges seamlessly by meta-transfer learning contextual invariances cross domain, e.g., from dense source domain to sparse target domain. Other embodiments may be described and/or claimed.

### CROSS-REFERENCE TO RELATED APPLICATION

This application claims the benefit of provisional Patent Application Ser. No. 62/914,644 filed Oct. 14, 2019, and entitled “META-TRANSFER LEARNING VIA CONTEXTUAL INVARIANTS FOR CROSS-DOMAIN RECOMMENDATION,” the contents of which are incorporated herein by reference in their entirety.

### BACKGROUND

Recommender systems are used in a variety of applications. They affect how users interact with products, services, and content in a wide variety of domains. However, the rapid proliferation of users, items, and their sparse interactions with each other has presented a number of challenge in making useful, accurate recommendations.

Thus, there is a need for recommendation systems that address data sparsity issues in practice. Traditional collaborative filtering methods as well as the more scalable neural collaborative filtering (NCF) approaches continue to suffer from sparse interaction data. Embodiments of the present disclosure address the problems for sparse interaction data, as well as other issues.

### BRIEF DESCRIPTION OF THE DRAWINGS

FIG. 1A illustrates an example of a system architecture in accordance with various embodiments of the present disclosure.

FIG. 1B illustrates an example of a computer system that may be used in conjunction with embodiments of the present disclosure.

FIGS. 2A, 2B, and 2C illustrates examples of processes for a recommendation system in accordance with various embodiments.

FIGS. 3A and 3B illustrate examples of components and process flows for recommendation systems in accordance with various embodiments.

FIG. 4 illustrates elements and features for recommendation systems in accordance with various embodiments.

FIG. 5 provides data tables referenced in the specification.

FIGS. 6A, 6B, and 6C illustrate data graphs according to various aspects of the present disclosure.

FIGS. 7 and 8 provide data tables referenced in the specification.

FIG. 9 is a performance heat map according to various aspects of the present disclosure.

FIGS. 10 and 11 illustrate data visualizations according to various aspects of the present disclosure.

FIG. 12 illustrates a graph of model training time according to various aspects of the present disclosure.

FIG. 13 illustrates an example of components and process flow of a training pipeline in accordance with various embodiments.

FIG. 14 illustrates an example of components and process flow of recommender system implemented as a three-tier web application in accordance with various embodiments.

FIG. 15 illustrates an example of a user interface in accordance with various embodiments.

### DETAILED DESCRIPTION

Various embodiments of the present disclosure may be used in conjunction with cross-recommendation systems to alleviate data sparsity concerns. In particular, some embodiments are directed to a recommendation framework that addresses data sparsity and data scalability challenges seamlessly by meta-transfer learning contextual invariances cross domain, e.g., from dense source domain to sparse target domain. quack

The following description is presented to enable one of ordinary skill in the art to make and use embodiments of the disclosure and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations.

Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the embodiments of the disclosure. The exemplary embodiments will also be described in the context of particular methods having certain steps. However, the method and system operate effectively for other methods having different and/or additional steps and steps in different orders that are not inconsistent with the exemplary embodiments. Thus, the present disclosure is not intended to be limited to the embodiments shown, but is to be accorded the widest scope consistent with the principles and features described herein.

Conventional systems typically have either employed co-clustering via shared entities, latent structure transfer, or a hybrid approach involving both. Depending on the definition of a recommendation domain, the challenge presents itself in different forms. In the pairwise user-shared (or item-shared) cross-domain setting, the user-item interaction structure in the dense domain is leveraged to improve recommendations in the sparse domain, grounded upon the shared entities. However the non-pairwise setting is pervasive in real-world applications, such as geographic region based domains, where regional disparities in data quality and volume must be alleviated (e.g., restaurant recommendation in densely populated urban cities vs sparsely populated towns). In such a challenging few-dense-source, many-sparse-target setting, the shared entity approach (shared users, items, external context) in conventional systems often fails to prove effective. Further, there are significant privacy concerns with directly sharing user data across domains.

In recent times, gradient based meta-learning has been proposed as a framework to few-shot adapt (e.g., with a small number of samples) a single base learner to multiple semantically similar tasks. One potential approach for cross-domain recommendation is to meta-learn a single base-learner based on its sensitivity to domain-specific samples. However, task agnostic base-learners are constrained to simpler architectures (such as shallow neural networks) to prevent overfitting, and require gradient feedback across multiple tasks at training time. This strategy scales poorly to the embedding learning problem in NCF, especially in the many-sparse-target setting, where adapting to each new target domain entails the embedding-learning task for its user sets and item sets.

The rapid proliferation of users, items, and their sparse interactions with each other in the social web in recent times has aggravated the grey-sheep user/long-tail item challenge in recommender systems. While cross-domain transfer-learning methods have found partial success in mitigating interaction sparsity, they are often limited by user or item-sharing constraints or significant scalability challenges or and lack of co-clustering data when applied across multiple sparse target recommendation domains (e.g., the one-to-many transfer setting). The learning-to-learn paradigm of meta-learning and few-shot learning has found great success in the fields of computer vision and reinforcement learning.

Among other things, embodiments of the present disclosure help to decompose a complex learning problem into a task invariant meta-learning component that can be leveraged across multiple related tasks to guide the per-task learning component (hence referred to as learn-to-learn). Embodiments of the present disclosure help to provide the simplicity and scalability of direct neural layer-transfer to learn-to-learn collaborative representations by leveraging contextual invariants in recommendation. Embodiments of this disclosure also provide an inexpensive and effective residual learning strategy for the one-dense to many-sparse transfer setting in recommendation applications.

Embodiments of the present disclosure can also leverage meta-learning and transfer learning to address the challenging one-to-many cross-domain recommendation setting without any user or item sharing constraints. As described in more detail below, embodiments of the present disclosure may define the shared meta-learning problem grounded on recommendation context. Transferrable recommendation domains provide semantically related or identical context to user-item interactions, providing deeper insights to the nature of each interaction.

Embodiments of the present disclosure may be implemented in conjunction with recommender systems for a variety of applications involving transactions for different entities. For example, in some embodiments a recommender system may be used in conjunction with a payment processing system to provide recommendations regarding various entities such as merchants (e.g., restaurants, hotels, rental car agencies, etc.) to users of the payment processing system.

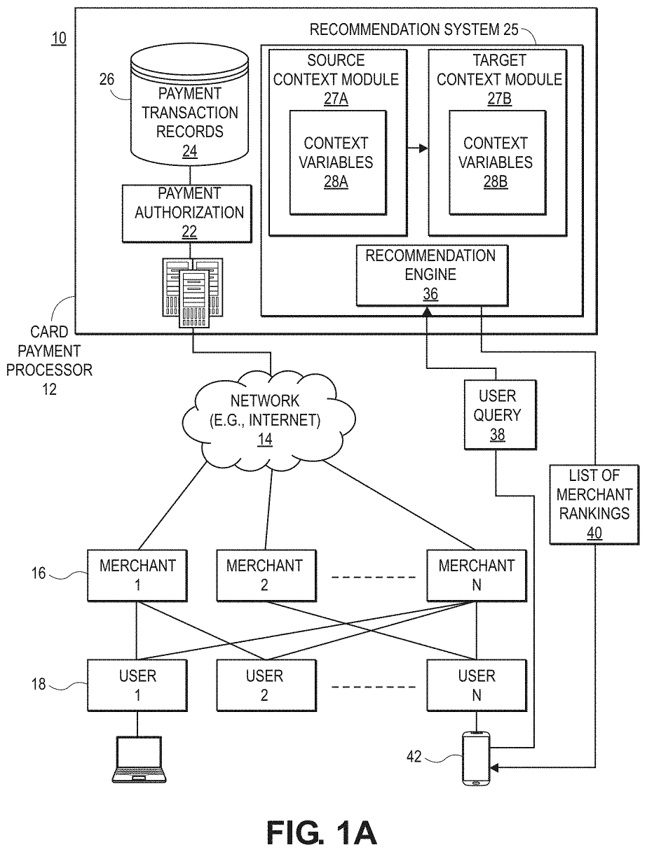

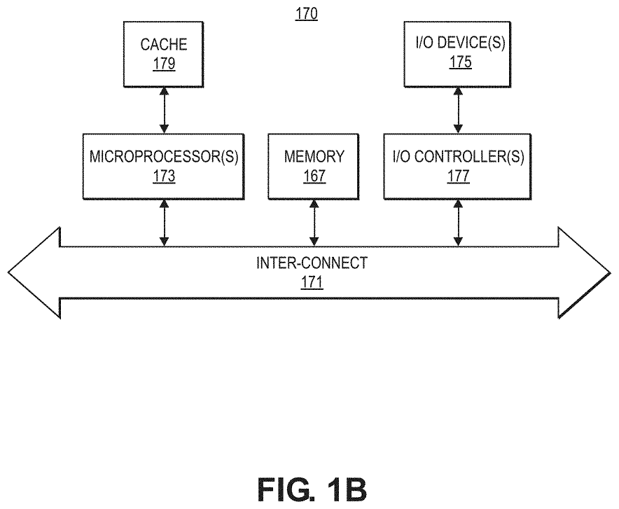

FIG. 1A is a block diagram illustrating an example of a card payment processing system in which the disclosed embodiments may be implemented. In this example, the card payment processing system 10 includes a card payment processor 12 in communication (directly or indirectly over a network 14) with a plurality of merchants via merchant systems 16. A plurality of cardholders or users purchase, via user systems 18, goods and/or services from various ones of the merchants using a payment card such as a credit card, debit card, prepaid card and the like.

Typically, the card payment processor 12 provides the merchants 16 with a service or device that allows the merchants to accept payment cards as well as to send payment details to the card payment processor 12 over the network 14. In some embodiments, an acquiring bank or processor (not shown) may forward the credit card details to the card payment processor 12.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet.”

The user systems 18 and merchant systems 16 can communicate with the card payment processor system 12 by encoding, transmitting, receiving, and decoding a variety of electronic communications using a variety of communication protocols, such as by using TCP/IP and/or other Internet protocols to communicate, such as HTTP, FTP, AFS, WAP, etc. In an example where HTTP is used, each user system 18 or merchant system 16 can include an HTTP client commonly referred to as a “web browser” or simply a “browser” for sending and receiving HTTP signals to and from an HTTP server of the system 12.

The user systems 18 and merchant systems 16 can be implemented as any computing device(s) or other data processing apparatus or systems usable by users to access the database system 16. For example, any of systems 16 or 18 can be a desktop computer, a work station, a laptop computer, a tablet computer, a handheld computing device (e.g., as shown for user computing device 42), a mobile cellular phone (for example, a “smartphone”), or any other Wi-Fi-enabled device, wireless access protocol (WAP)-enabled device, or other computing device capable of interfacing directly or indirectly to the Internet or other network.

Payment card transactions may be performed using a variety of platforms such as brick and mortar stores, ecommerce stores, wireless terminals, and user mobile devices. The payment card transaction details sent over the network 14 are received by one or more servers 20 of the payment card processor 12 and processed by, for example, by a payment authorization process 22 and/or forwarded to an issuing bank (not shown). The payment card transaction details are stored as payment transaction records 24 in a transaction database 26. Servers 20, merchants systems 16, and user systems 18 may include memory and processors for executing software components as described herein. An example of a computer system that may be used in conjunction with embodiments of the present disclosure is shown in FIG. 1B and described below.

The most common type of payment transaction data is referred to as a level 1 transaction. The basic data fields of a level 1 payment card transaction are: i) merchant name, ii) billing zip code, and iii) transaction amount. Additional information, such as the date and time of the transaction and additional cardholder information may be automatically recorded, but is not explicitly reported by the merchant 16 processing the transaction. A level 2 transaction includes the same three data fields as the level 1 transaction, and in addition, the following data fields may be generated automatically by advanced point of payment systems for level 2 transactions: sales tax amount, customer reference number/code, merchant zip/postal code tax id, merchant minority code, merchant state code.

In the example illustrated in FIG. 1A, the payment processor 12 further includes a recommendation system 25 that provides personalized recommendations to users 18 based on each user's own payment transaction records 24 and past preferences of the user and other users 18. The recommendation engine 36 is capable of recommending any type of merchant, such as restaurants, hotels, and others.

As described in more detail below, the merchant recommendation system 25 retrieves the payment transaction records 24 to determine context variables 28a, 28b associated with merchants 16 and users 18. The system generates a source recommendation meta-model that includes a source context module 27a based on a source set of context variables 28a. Similarly, the system generates a target recommendation meta-model with a target context module 27b that is based on a target set of context variables 28b. The system 25 transfers the source context module 27a to the target context module.

The source context module 27a and target context module 27b may be used by a recommendation engine 36 to provide personalized recommendations to a user, such as recommendations for a particular merchant from the set of merchants, for example. The recommendation engine 36 can respond to a user query 38 (also referred to herein as a “recommendation request”) from a user 18 and provide a list of merchant rankings 40 in response. Alternatively, the recommendation engine 36 may push the list of merchant rankings 40 to one or more target users 18 based on current user location, a recent payment transaction, or other metric. In one embodiment, the user 18 may submit the recommendation request 38 through a payment card application (not shown) running on a user device 42, such as a smartphone or tablet. Alternatively, users 18 may interact with the merchant recommendation system 25 through a web browser.

Both the server 20 and the user devices 42 may include hardware components of typical computing devices, including a processor, input devices (e.g., keyboard, pointing device, microphone for voice commands, buttons, touchscreen, etc.), and output devices (e.g., a display device, speakers, and the like). The server 20 and user devices 42 may include computer-readable media, e.g., memory and storage devices (e.g., flash memory, hard drive, optical disk drive, magnetic disk drive, and the like) containing computer instructions that implement the functionality disclosed herein when executed by the processor. The server 20 and the user devices 42 may further include wired or wireless network communication interfaces for communication.

Although the server 20 is shown as a single computer, it should be understood that the functions of server 20 may be distributed over more than one server, and the functionality of software components may be implemented using a different number of software components. For example, the recommendation system 25 may be implemented as more than one component. In an alternative embodiment (not shown), the server 20 and recommendation system 25 of FIG. 1a may be implemented as a virtual entity whose functions are distributed over multiple computing devices, such as by user systems 18 or merchant systems 16.

FIG. 1B shows a computer system 170 for implementing or executing software instructions that may carry out the functions of the embodiments described herein according to various embodiments. For example, computer system 170 may comprise server 20, a merchant system 16, user system 18, or user mobile device 42 illustrated in FIG. 1A. The computer system 170 can include a microprocessor(s) 173 and memory 172. In an embodiment, the microprocessor(s) 173 and memory 172 can be connected by an interconnect 171 (e.g., bus and system core logic). In addition, the microprocessor 173 can be coupled to cache memory 179. In an embodiment, the interconnect 171 can connect the microprocessor(s) 173 and the memory 172 to input/output (I/O) device(s) 175 via I/O controller(s) 177. I/O devices 175 can include a display device and/or peripheral devices, such as mice, keyboards, modems, network interfaces, printers, scanners, video cameras and other devices known in the art. In an embodiment, (e.g., when the data processing system is a server system) some of the I/O devices (175), such as printers, scanners, mice, and/or keyboards, can be optional.

In an embodiment, the interconnect 171 can include one or more buses connected to one another through various bridges, controllers and/or adapters. In one embodiment, the I/O controllers 177 can include a USB (Universal Serial Bus) adapter for controlling USB peripherals, and/or an IEEE-1394 bus adapter for controlling IEEE-1394 peripherals.

In an embodiment, the memory 172 can include one or more of: ROM (Read Only Memory), volatile RAM (Random Access Memory), and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

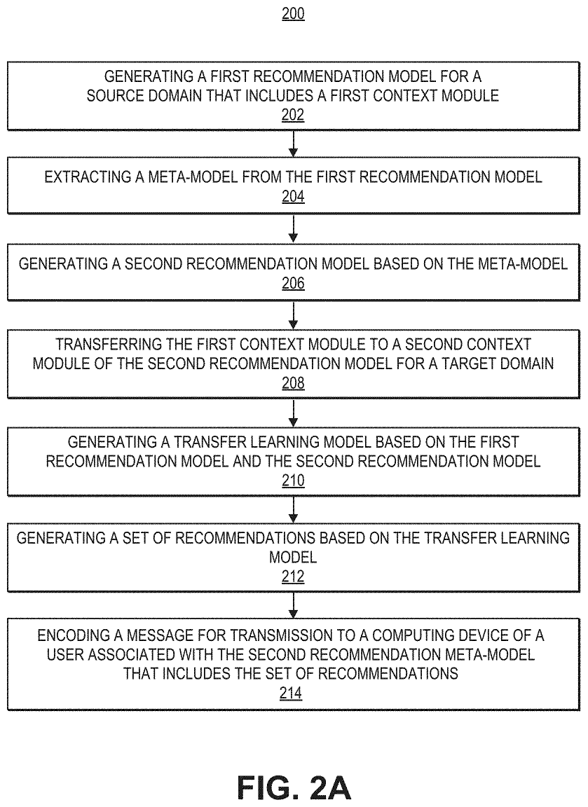

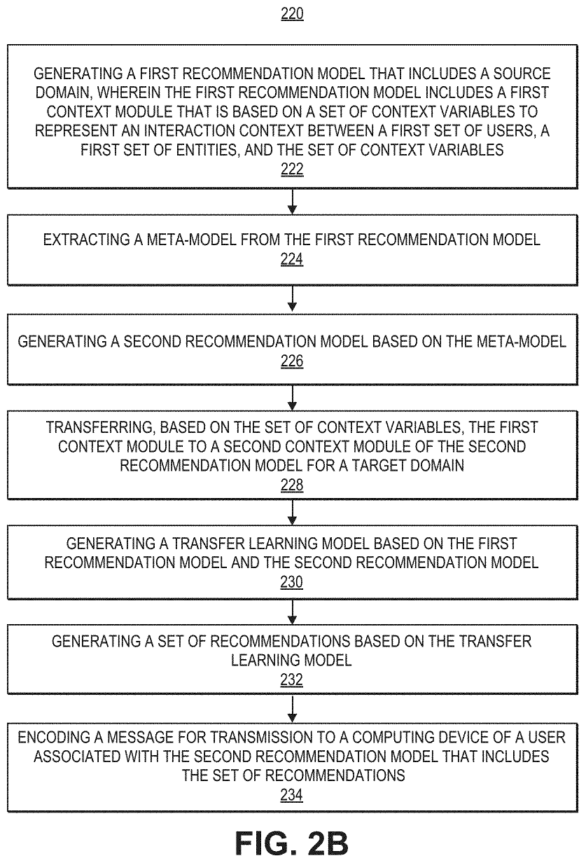

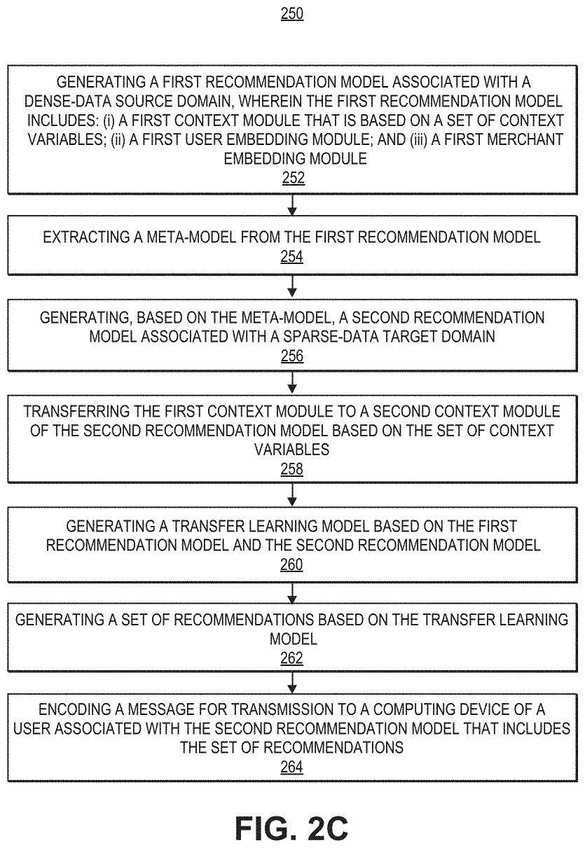

FIGS. 2A-2C illustrate examples of processes that may be performed by one or more computer systems, such as by one or more of the systems illustrated in FIG. 1A. Any combination and/or subset of the elements of the methods depicted herein may be combined with each other, selectively performed or not performed based on various conditions, repeated any desired number of times, and practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

In the example depicted in FIG. 2A, process 200 includes generating a first recommendation meta-model for a source domain that includes a first context module (202), extracting a meta-model from the first recommendation model (204), generating a second recommendation model based on the meta-model (206), transferring the first context module to a second context module of the second recommendation model for a target domain (208), generating a transfer learning model based on the first recommendation model and the second recommendation model (210), generating a set of recommendations based on the transfer learning model (212), and encoding a message for transmission to a computing device of a user associated with the second recommendation meta-model that includes the set of recommendations (214).

In the example depicted in FIG. 2B, process 220 includes, at 222, generating a first recommendation model that includes a source domain, wherein the first recommendation model includes a first context module that is based on a set of context variables to represent an interaction context between a first set of users, a first set of entities, and the set of context variables. Process 220 further includes Extracting a meta-model from the first recommendation model (224), generating a second recommendation model based on the meta-model (226), transferring, based on the set of context variables, the first context module to a second context module of the second recommendation model for a target domain (228), generating a transfer learning model based on the first recommendation model and the second recommendation model (230), generating a set of recommendations based on the transfer learning model (232), and encoding a message for transmission to a computing device of a user associated with the second recommendation model that includes the set of recommendations (234).

In the example depicted in FIG. 2C, process 250 includes, at 252, generating a first recommendation model associated with a dense-data source domain, wherein the first recommendation model includes: (i) a first context module that is based on a set of context variables; (ii) a first user embedding module; and (iii) a first merchant embedding module. Process 250 further includes extracting a meta-model from the first recommendation model (254), generating, based on the meta-model, a second recommendation model associated with a sparse-data target domain (256), transferring the first context module to a second context module of the second recommendation model based on the set of context variables (258), generating a transfer learning model based on the first recommendation model and the second recommendation model (260), generating a set of recommendations based on the transfer learning mode (262), and encoding a message for transmission to a computing device of a user associated with the second recommendation model that includes the set of recommendations (264).

Context variables that may be used in conjunction with the present disclosure are described in more detail below. In some embodiments, a set of context variables in the first context module are associated with a first set of transaction records associated with a dense-data source domain, and the second context module is based on a second set of transaction records associated with the sparse-data target domain.

A variety of context variables may be used in conjunction with embodiments of the present disclosure. For example, the context variables for the first context module or the second context module include: an interactional context variable associated with a condition under which a transaction associated with a user occurs; a historical context variable associated with a past transaction associated with a user; and/or an attributional context variable associated with a time-invariant attribute associated with a user.

The recommendation meta-models described in conjunction with embodiments the present disclosure may have the same, or different components. For example, modules described below as being included in a first recommendation model for a dense-data source domain may be likewise included in a second recommendation model for a sparse-data target domain.

In some embodiments, the first recommendation model further includes a first user embedding module that is to index an embedding of the first set of users within the dense-data source domain, and the second recommendation model includes a second user embedding module that is to index an embedding of a second set of users within the sparse-data target domain. In such cases, transferring the first context module to the second context module does not include transferring the first user embedding module to the second user embedding module.

In some embodiments, the first recommendation model further includes a first entity embedding module that is to index an embedding of the first set of entities within the dense-data source domain, and the second recommendation model includes a second entity embedding module that is to index an embedding of a second set of entities within the sparse-data target domain. In such cases, transferring the first context module to the second context module does not include transferring the first entity embedding module to the second entity embedding module.

In some embodiments, the first recommendation model further includes a first user context-conditioned clustering module that is to generate clusters of the first set of users within the dense-data source domain, and the second recommendation meta-model includes a second user context-conditioned clustering module that is to generate clusters of a second set of users within the sparse-data target domain. In such cases, transferring the first context module to the second context module does not include transferring the first user context-conditioned clustering module to the second user context-conditioned clustering module.

In some embodiments, the first recommendation model further includes a first entity context-conditioned clustering module that is to generate clusters of the first set of entities within the dense-data source domain, and the second recommendation meta-model includes a second entity context-conditioned clustering module that is to generate clusters of a second set of entities within the sparse-data target domain. In such cases, transferring the first context module to the second context module does not include transferring the first entity context-conditioned clustering module to the second entity context-conditioned clustering module. Additionally, the first recommendation model further includes a first mapping module that is to map the clusters of the first set of users and the first set of entities, and the second recommendation meta-model includes a second mapping module that is to map the clusters of the second set of users and the second set of entities.

In some embodiments, the first set of recommendations includes a subset of the first set of entities recommended for a user from first set of users.

In some embodiments, the first context module and the second context module share one or more context transformation layers.

In some embodiments, the system may generate a collaborative filtering model based on a randomized sequence of user interactions associated with a third set of entities, wherein the third set of entities includes an entity not present in the first set of entities or a second set of entities associated with the second recommendation meta model. The system may further generate a popularity model based on a total number of transactions associated with each entity from the first set of entities, second set of entities, and third set of entities, wherein the second set of recommendations are further generated based on the collaborative filtering model and the popularity model.

Context variables may be used in embodiments of the disclosure in learning-to-organize the user and item latent spaces. The following describes three different types of context features.

Interactional Context: These predicates describe the conditions under which a specific user-item interaction occur, e.g., time or day of the interaction. They can vary across interactions of the same user-item pair.

Historical Context: Historical predicates describe the past interactions associated with the interacting users and items, e.g., user's interaction pattern for an item (or, item category).

Attributional Context: Attributional context encapsulates the time-invariant attributes, e.g., user demographic features or item descriptions. They do not vary across interactions of the same user-item pair.

Embodiments of the present disclosure may utilize combinations of context features to analyze and draw inferences about the interacting users and items. For instance, an Italian wine restaurant (attributional context) may be a good recommendation for a user with historically high spending (historical context) on a Friday evening (interactional context). However, the same recommendation may be a poor choice on a Monday afternoon, when the user goes to work. Thus the intersection of restaurant type, user's historical habits and transaction time are influential on the likelihood of this interaction being useful to the user. Such behavioral invariants can be inferred from a dense-source offering sufficient interaction histories of users with wine restaurants, and applied to improve recommendations in a sparse-target domain with less interaction data.

Users who engage in interactions with items under similar combinations of contextual predicates may be clustered in the user embedding spaces and recommended the appropriate clusters of items that cater to their preferences tastes. While the user and item embedding are specific to each domain, embodiments of the disclosure may provide a meta-learning approach grounded on contextual predicates to organize the embedding spaces of the target recommendation domains (e.g., learn-to-learn embedding representations) which is shared across the source and target domains. Embodiments of the disclosure may utilize the presence of behavioral contextual/behavioral invariants that dictate user choices, and their application to generate more descriptive embedding representations.

In some embodiments, a meta-transfer approach explicitly controls for overfitting by reusing the meta layers learned on a dense source domain. Some embodiments may provide an adaptation (or transfer) approach based on regularized residual learning with minimal overheads to accommodate new target domains. In some embodiments, only the residual layers and user/item embedding are learned on a per-domain basis, while transferring the source model layers directly. This is a particularly novel contribution in comparison to existing transfer-learning work, and enables adaptation to several target domains with a single source-learned meta model. It also offers flexibility to define the shared aspects modeled by the meta layers and the advantages of rapid prototyping via adaptation to new users, items or domains. This disclosure proceeds by summarizing a number of features that may be employed by embodiments of the present disclosure.

Meta-Learning via Contextual Invariants: Embodiments may develop the meta-learning problem of learning to learn NCF embeddings via cross-domain contextual invariants. While invariants are intuitive and well-defined for computer vision and other visual application tasks, it may not be apparent as to what an accurate mapping of latent features across recommendation domain should embody. Embodiments of the disclosure may provide a class of pooled contextual predicates that can be effectively leveraged to address the sparsity problem of data-sparse recommendation domains.

Meta-Transfer via Residual and Distributional Alignment: Some embodiments may be used to learn a single central meta-model which forms the key associations of contextual factors that contribute to a user-item interaction. This central model may not be learned separately for each data pocket since all of them do not provide the high quality dense data that is required to extract the important associations. In some embodiments, it is sufficient to learn the meta model for the rich and dense source data, and enable scaling to many target domains with an inexpensive and effective residual learning strategy.

Rapid Prototyping: A desirable characteristic of real-world recommender systems, such as recommendation system 25 in FIG. 1A, is the ability to rapidly generate models for new data (such as data pockets or regions). Furthermore, the generated models require updates to leverage recent interaction activity and the evolution of user preferences. The contextual factors that underlie user-item inter-actions are temporally and geographically invariant (except for residual adaptation), thereby enabling the majority of models of the present disclosure to not require updates.

Robust Experimental Results: Embodiments of the present disclosure demonstrate strong experimental results, both within and across recommendation domains on three different datasets—two publicly available datasets as well as a large financial transaction dataset from a major global payments technology company. These results demonstrate the gains of embodiments of the present disclosure on low-density and low-volume targets by transferring the meta-model learned on the dense source domain.

This disclosure proceeds by summarizing related work, formalizing problems addressed by various embodiments, describing approaches that may be taken in various embodiments, and evaluating the proposed framework. Below is a summary of a few related efforts that attempt to address the sparse inference problem.

Explicit Latent Structure Transfer: The codebook recommendation transfer mode/transfers the principal components of the non-negative matrix factors of user and item subspaces. However, in reality, this approach is unrealistic since most recommendation domains show significant variations in rating patterns and cluster structure. Some conventional approaches proposed to transfer a shared cluster structure for users across related recommendation domains, while permitting a second domain specific component. However, adding degrees of freedom to sparse domains further hurts their inference quality.

Manifold Mapping: Manifold mapping is in principal similar to the previous class of models, however, the mapping between the latent factors is more data driven and flexible than principal component alignment. The key weakness of this line of work is the dependence on shared users or items to help map the clusters or high density regions in the respective subspaces.

Transfer via Shared Entities: Numerous techniques have been proposed in conventional systems to exploit shared users and/or items across domains as anchor points to improve inference quality in the sparse domain. Broadly, these include co-clustering, shared content methods, and more recently, joint methods to combine both sources of commonality across domains. It is hard to quantify the volume of shared content or entities (users/items) that can effectively facilitate transfer in this setting. It is generally inapplicable to the one-to-many transfer setting owing to user and item sharing constraints. It also scales poorly to non-pairwise transfer setting.

Layer Transfer Methods: A wide-array of direct deep layer transfer techniques have been proposed in the Computer Vision (CV) space for transfer learning across semantically correlated classes of images, and mutually dependent tasks such as image classification and image segmentation. It has been shown, however, that transferability is restricted to the initial layers of deep CV models that extract geometric invariants and rapidly drops across semantically uncorrelated classes of images. In the latent factor recommendation methods, there is no direct way to map layers across recommendation domains. Since the latent representations across domains are neither interpretable nor permutation invariant, it is much harder to establish a reliable and principled cross-domain layer transfer method. Among other things, embodiments of the present disclosure provide a novel invariant for the recommendation domain that enables embodiments to meta-learn shared representation transforms.

Meta Learned Transformation of User and Item Representations: In this line of work, a common transform function is learned to interpret each user's item history and employ the aggregated representation to make future recommendations. The key proposal is to share this transform function across users, enabling a meta-level shared model across sparse and dense users. The cross-domain setting is accommodated with bias adaptation in the non-linear transform. Although this approach can address some of the above shortcomings, it is only applicable to the explicit feedback scenario (since it assumes 2 classes of items—accepted and rejected). The technique is not grounded on a principled set of invariants. Further, the learned function must explicitly aggregate each user's item history resulting in scalability issues over large datasets.

Prior work has considered algorithm selection and intelligent hyper-parameter initialization and meta-learned training curriculum for cross-domain adaptation. Although very generalizable, meta-training curriculums still rely on training separate models on each target domain, which is inefficient when there is a significant overlap in knowledge as in most linked-domain applications. Additionally, the transferability across semantically diverse domains is weak. These efforts also assume the availability of pre-trained embeddings for users and items, while embodiments of the present disclosure, by contrast, are able to leverage meta-learning for learning-to-learn the embedding spaces of the target domains.

The following section provides details on the problem definition(s) addressed by embodiments of the present disclosure. A recommendation domain D may be represented as a set, D={ [symbol] _{D}, V_{D}, [symbol] _{D}}, where [symbol] _{D}, V_{D} denote the user and item sets in D, and ID, the set of interactions. In some embodiments, it may be assumed no overlap of the user and item sets across recommendation domains, but the idea is applicable to domains with shared users or items. Each interaction iϵI_{D} is a tuple t=(u, v, c) where uϵ [symbol] _{D}, VϵV_{D} and context vector c∈ [symbol] ^{|C|}.

Interaction context vectors c contain the same feature set C for all transactions. The context feature set C concatenates the three different types of context, C_{I}, C_{H}, C_{A}, denoting interaction, historical and attributional context features of each transaction. The interaction context vector c is thus a concatenation of the three subsets c=[c_{I}, c_{H}, C_{A}]. Note that for a fixed user-item pair, c_{A} is the same in every interaction, while c_{I}, c_{H} may vary. For simplicity the same context feature set may be assumed across domains. Embodiments of the present disclosure may be extended to the case where they differ, by introducing a domain-specific layer for uniformity.

In the implicit feedback setting, embodiments may rank items V_{D} given user uϵ [symbol] _{D} and the desired interaction context c. For the explicit feedback setting, the interaction set is replaced by rating set [symbol] _{D}, where each rating is a tuple r=(u, v, rᵤᵥ, c), rᵤᵥ is the star-value of the rating (other notations are the same). Note that in the implicit feedback setting, users may interact with items more than once, while user-item pairs can appear at most once in explicit ratings. In the explicit feedback setting, embodiments may predict the rating value rᵤᵥ given the user, item and rating context triple (u, v, c).

CONTEXT DRIVEN META LEARNER. This section proceeds by formulating the context of a driven meta problem shared across dense and sparse recommendation domains, describes examples of proposed modular architecture and modules that may be used in conjunction with some embodiments, and develops a variance-reduction training approach to the model to the source domain. Subsequently, algorithms to facilitate the transfer of the meta learner to the target domains are described in Section 6.3.

4.1 Meta-Problem Formulation

Users who engage in interactions with items may be motivated by underlying behavioral invariants that do not change across the recommendation domains. Accordingly, embodiments of the present disclosure may infer the most important aspects of the interaction context to describe such behavior patterns, and leverage them to learn representative embedding spaces as part of a learn-to-learn formulation. These invariants may be learned on a dense and representative source domain, where it is expected to see them manifest in the observed user-item interactions.

Some contextual invariants appear at the intersection of multiple contextual features. For instance, changing a single context feature such as time of the day could drastically alter the likelihood of a certain set of user-item interactions. Additive models do not adequately capture such an interaction, and past work has even shown deep neural networks driven by linear transforms struggle to infer pooled or multiplicative factors. Embodiments of the present disclosure may provide a multi-linear low rank pooled representation to capture the invariant context transforms describing user behavior.

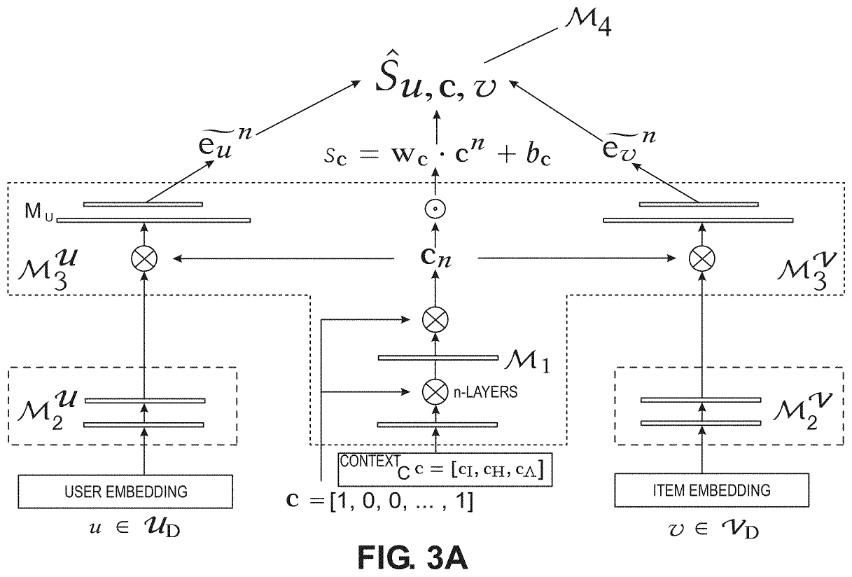

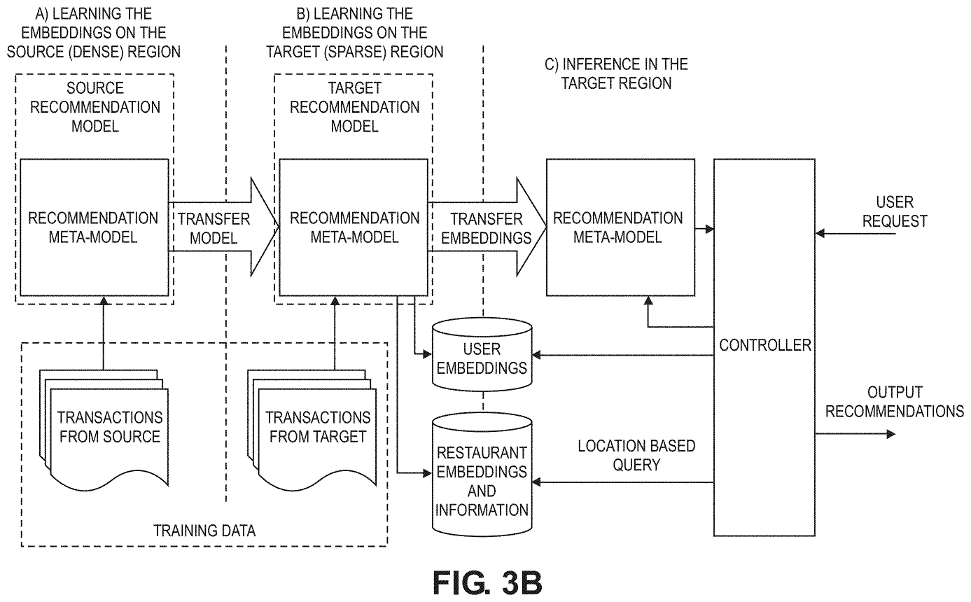

FIG. 3A illustrates an example of neural parameterization and an example of a software architecture that may be utilized in conjunction with various embodiments. In this example, the architecture includes four components, a context module, embedding modules, context-conditioned clustering modules, and mapping modules.

Context Module [symbol] ₁: The context transform module extracts low-rank multilinear context combinations characterizing each user-item interaction.

Embedding Modules [symbol] : These modules index the embeddings of users (U) and items (V, e.g., merchants), respectively. They are flexible to multiple scenarios—learning embeddings from scratch, learning transforms on top of pre-trained embeddings etc. [symbol] ₂ may denote the user and item embedding matrices in experiment results shown below.

Context Conditioned Clustering Modules [symbol] : These modules cluster the user and item embeddings conditioned on the context of the interaction. Thus the same user could be placed in two different clusters for two different contexts (e.g., when the user is home vs. when traveling).

Mapping Module [symbol] ₄ Maps the context conditioned user and item clusters to generate the most likely interactions under the given context.

The importance of low-rank pooling: Embodiments of the disclosure may extract the most informative contextual combinations to describe each interaction. Specifically, the output of the context transform component is composed of n-variate combinations of the contextual features. Embodiments of the disclosure help enable data driven selection of pooled n-variate factors to prevent a combinatorial explosion of the factors. Further, a very small proportion of possible combinations may play a significant role in the recommendations made to users, and embodiments of this disclosure helps enable adaptive weighting among the chosen set of multi-linear factors.

Embodiments of the present disclosure may employ multiple strategies to achieve low-rank multi-linear pooled context combinations and transform the user and item embedding spaces conditioned on these factors. FIG. 3B illustrates an example of the components and process flow for a recommendation system with meta-transfer learning according to various embodiments of the disclosure, as described herein.

Context Transform Module [symbol] ₁. Recursive Hadamard Transformation: Referring again to FIG. 3A, each layer performs a linear projection followed by an element wise sum with a scaled version of the raw context, c. The result is then transformed with an element-wise product (also referred to as a Hadamard product) with the raw context features, enabling a product of each context dimensions with any weighted linear combination of the rest (including higher powers of the terms). The resulting recursive computations may be referred to as the Recursive Hadamard Transformation, with several learned components in the linear layers determining the end outputs.

Given the input context vector c, the transform of each layer can be described as follows—c₂=σ(W₂c⊗(b₂⊗c))⊗c. From this, c₂ can extract features of the form, (W₂)ᵢⱼcᵢcⱼ, (b₂)ᵢcᵢ². Similarly, layer-n preforms the transform, cₙ=σ(Wₙcₙ₋₁⊗(bₙ⊗cₙ₋₁))⊗c, (c₂)ᵢ=cᵢ×Σⱼ₌₁^{|c|}W_{i,j}¹ cⱼ=Σⱼ₌₁^{|c|}W_{i,j}¹ cᵢcⱼ. Similarly, layer-n an extract n-variate weighted sum terms of the form ΣW¹ W² . . . Wⁿ×cᵢ_{₁}cᵢ_{₂}cᵢ_{₃} . . . cᵢ_{ₙ}.

Hadamard Projector Pooling: Some embodiments may provide a novel Hadamard Memory Network (HMN) to achieve low-rank multi-linear pooling with a more expressive projection strategy. Embodiments may learn a set of k memory blocks (each row or block is a Hadamard projector with the same length as the context vector, |c|), given by M∈ [symbol] ^{k×|c|}. The first order transform of c is given by the concatentation of its k Hadamard projections along each projector M₁, followed by a feedforward operation to reduce the dimension of the concatenated projections to |c|. The first-order transform is then element wise multiplied with the context vector to obtain the second order context vector.

c²=σ(W¹(c⊗M₁·c⊗M₂. . . c⊗Mₖ)+b¹)⊗c

where denotes concatenation and ⊗ is the Hadamard product.

The second order transform is now obtained by projecting and concatenating the second order context, and reduced by |c| dimensions by a second feedforward operation. The third order context c³ is obtained by the element wise product of the second order transform with the first order context c.

c³=σ(W²(c²⊗M₁·c²⊗M₂. . . c²⊗Mₖ)+b²)⊗c

The resulting multi-linear pooling incorporates k-times the expressivity of the previous strategy, but also incurs a k-fold increase in computation and parameter costs. Note however, that the training costs are one-time (only on the dense source domain).

Multimodal Residuals for Discriminative Correlation Mining: Note that each transaction is described by three modes of context, Historical, Attributional and Interaction. The previously described Recursive Hadamard Strategy learns multi-linear pooled transformations of the form w₁, w₂, . . . , wₖ×c₁, c₂, . . . , cₖ. Consider the co-occurrence of a specific pair of strongly correlated context indicators, cₓ and c_{y}, and that of cₓ and a relatively weaker correlated indicator, c_{z}. The signal cₓ is expected to play a greater role in the predicted output in the presence of c_{y} than if only c_{z} were present. Embodiments may model a multi-modal degree of freedom to enhance two modes (or indicators) of the context variables conditioned on their presence or absence. This translates to the transform,

cₓ=cₓ+δ_{c}_{ₓ}_{|c}_{_{y}}

c_{y}=c_{y}+δ_{c}_{_{y}}_{|c}_{ₓ}

Given strongly correlated context indicators, cx and cy, pooled terms containing cx, cy are either enhanced or diminished by this transformation, depending on their residual values. Each context mode is enhanced or diminished as a combined function of the other two modes, e.g.,

δ_{c}_{₁}=s_{I}⊗ tanh(W_{I}[c_{H};c_{A}]+b_{I})

and likewise for δ_{c}_{_{H}} and δ_{c}_{_{A}} with the other two modes appearing on the right side of the equation. Note that a scaling parameter s and weight W are learned for each context mode. The above residual transforms are applied to raw context c prior to the first transformation layer to enable a cascading effect over the other layers.

4.2.2 Embedding Mapping and Context Conditioned Clustering, [symbol] ₂, [symbol] ₃.

The user embedding space, eᵤ, uϵ [symbol] ₘ is organized to reflect the contextual preferences of users. To achieve this organization of the embeddings, the meta-model may backpropagate the extracted multi-linear context embeddings cⁿ into the user embedding space and create context conditioned clusters of users for item ranking. The precise motivation holds good for the item embedding space as well.

[symbol]

=eᵤ⊗cⁿ

where cⁿ denotes the nth context transform output for the context c of some interaction of user u. Similarly, given item embedding, eᵥ, i∈V_{D},

[symbol]

=eᵥ⊗cⁿ

The bilinear layers eliminate the irrelevant dimensions of the user and item embeddings to generate the conditioned representations [symbol] and [symbol] . Bilinear layers also help maintaining emebedding dimension uniformity across domains, since the contextual features are transformed in an identical manner and backpropagated into their user spaces.

RelU feedforward layers are employed to transform and align the most suitable context conditioned user and item clusters,

[symbol]

¹=δ( [symbol] ¹ [symbol] + [symbol] ¹)

[symbol]

ⁿ=δ( [symbol] ⁿ [symbol] ⁿ⁻¹+ [symbol] ⁶⁶)

Similarly, embodiments may obtain the item cluster transform, [symbol] ⁿ. The score for u, v under context c (module [symbol] ₄) is reduced to just the dot product:

s_{u,v}= [symbol] ⁿ· [symbol] ⁿ

However in practice, the above loss function may result in uninteresting low-variance samples dominating the learning process, resulting in slower convergence, less novelty and inaccurate user representations. The next subsection discusses how these and other issues are addressed by embodiments of the present disclosure.

4.3 Training Algorithm

4.31 Self-Paced Curriculum Via Context Bias.

Past work has demonstrated the importance of focusing on harder samples to accelerate and stabilize SGD. Intuitively, some context factors make user-item interactions very likely, while not truly reflecting their interests. As an example, users may visit restaurants that are cheap and close to their location, even if they don't particularly like them. These examples also constitute a large proportion of the training samples, fewer examples exhibit novel or diverse interests of users and the corresponding context. Thus to de-correlate the common transactions, and accelerate SGD via prioritization of hard samples, some embodiments may compute a scalar value that only considers the context under which the transaction occurs. For instance, the bias to visit a low-cost restaurant in proximity to the user is expected to be significantly more than that of an expensive restaurant that is far away from the user. To obtain this context bias score, embodiments may train a model to learn a simple dot-product layer,

s_{c}=w_{c}·cⁿ+b_{c}

The bias term effectively explains the common and noisy transactions and thus limits the gradient impact on the embedding spaces, while novel or diverse transactions have a much lower bias value, and thus play a stronger role in determining the interests of users and characteristics of items. This can be seen as a novelty-weighted curriculum, where the novelty factor is ‘self-paced’, depending on the pooled factors learned in cⁿ.

4.3.2 Ranking Recommendations.

In implicit feedback setting, the likelihood score of user u preferring recommendation i under context c is obtained by the sum of the above two scores, s_{u,i}+s_{c}. In the explicit feedback setting, embodiments of the disclosure may introduce two additional bias terms, one for the user, sᵤ and one for the merchant or item, sᵢ. The intuition for the bias is that some users tend to provide higher ratings to items on average, although this may not truly reflect their preference. Conversely, a fine-dining restaurant is universally rated higher than a coffee shop. In some embodiments, it is not desirable for these item and user biases to pollute the embedding spaces and this eliminate their effect using the bias terms. Finally, some embodiments may use a global bias s in the explicit feedback setting to account for the scale of ratings (e.g., 0-5 scale vs 0-10).

Thus, the precise loss functions are as follows—

Implicit Feedback Scenario—

$${\hat{S}}_{u , c , v} = {2}^{} \cdot {2}^{} + {w}_{c} \cdot {c}^{n} + {b}_{c}$$

$${ℒ}_{u} = {\sum }_{i ϵ I}^{ } {\sum }_{c {ϵℝ}^{\vert c \vert}}^{ } {‖ {𝕀}_{u , c , v} - {\hat{S}}_{u , c , v} ‖}^{2}$$

Note [symbol] denotes the identity function indicating if a specific transaction between user, item u, v occurred under context c. It is easy to see that loss [symbol] ᵤ is intractable due to the large number of merchant and context combinations that can be constructed. Thus some embodiments may resort to the common practice of negative sampling in the implicit feedback scenario. In various embodiments, two types of negative samples to guide model training may be used, merchant negatives and context negatives.

Merchant Negatives: To avoid location bias in the learned embedding space, and explicitly capture the preferences of the user, the negatives for each user in the spatial neighborhood of the user's positives are identified, e.g., restaurants the user could have visited but chose not to. Embodiments may construct a spatial index based on quad-trees to facilitate inexpensive sampling of negative merchant samples.

Context Negatives: The context vector c is a binary vector denoting the attributional, historical and transactional context variables. Numerical attributes such as tip, spend and distance are converted to quantile representations (1 of k-quantile) to normalize for regional variations. To generative negative context samples, some embodiments may hold the merchant and user constant, while varying the context vector in one of two ways.

A Random Samples: Each context value is randomly sampled among the set of transactional context variables such as time of interaction. Note that historical and attributional context is left unchanged since the merchant and user are fixed across negative context samples.

B Dirichlet Mixture Model: Random sampling often results in unrealistic context variables that do not train the model since they are easy to distinguish. Some embodiments may utilize a topic modeling approach to capture the co-occurrence patterns of the different transactional context variables across all users. Note that the value of each context variable in the transactional context represents a word (since each context is discretized with the 1 of k-quantile approach, there is a finite number of words), and a specific combination of transactional contexts is a short sentence, adopting the DMM terminology. This set of ‘context topics’ may be denoted by T_{c}.

Each context vector c can then be denoted by a distribution P_{c} over the topics T_{c}. Some embodiments may create an orthagonal projection of P_{c} in the context topic space and sample a random negative context from the resulting mixture of context topics.

Loss function [symbol] ᵤ is then given by the sum over the positive samples (transactions Tᵤ) and negative samples (sampled with the above procedure) corresponding to each user with a suitable scaling component μ. All models may be trained with the ADAM optimizer and dropout regularization.

Explicit Feedback Scenario—

$${\hat{R}}_{u , c , v} = {n}^{} \cdot {3}^{} + {w}_{c} \cdot {c}^{n} + {b}_{c} + {s}_{u} + {s}_{v} + s$$

$${ℒ}_{u} = {\sum }_{v {ϵℝ}_{u}} {‖ {R}_{u , c , v} - {\hat{R}}_{u , c , v} ‖}^{2}$$

### 5 META TRANSFER TO SPARSE DOMAINS

This section discusses adaptation strategies to adapt the source-learned meta modules to sparse target domains that may be used in conjunction with various embodiments.

5.1 Direct Layer-Transfer and Annealing

5.1.1 Layer-Transfer. While direct layer-transfer has produced results across a range of Computer Vision tasks, it is often useful to tune the transferred layer to ensure optimal performance in the target domain. Embodiments of the present disclosure help to ensure compatibility of the embeddings learning across diverse domains (e.g., users who prefer expensive Italian cuisines on week-ends across two different states should occupy similar regions of the embedding spaces), and enable lateral scaling, e.g., the adaptation task must be inexpensive in computation and storage overheads for new sparse target domains.

One goal in the target domain is to learn representative user and merchant embeddings with a relatively low volume and density of transactional data. One strength of embodiments of this disclosure is to adapt the pre-determined contextual combinations, user and merchant clustering layers and back propagate through the pre-trained neural layers to organize the respective embedding spaces. This enables models generated by embodiments of the disclosure to efficiently leverage the smaller volume of transactional data in the target domain.

5.1.2 Annealing.

Some embodiments may adopt a simulated-annealing approach as to adapt the layers transferred from the source domain. This may help decay the learning rate for the transferred layers at a rapid rate (e.g., employing an exponential schedule), while user and item embeddings are allowed to evolve when trained on the target data points. Note that user and item embeddings may be annealed separately for each domain with the transferred meta-learner, and the domain-specific residual and distributional components are permitted to introduce independent variations in each domain.

Residual Shifting of Context Combinations—In some embodiments, residual learning may be used to learn a perturbation as a function of the latent embedding representation, rather than a direct transform. In some embodiments, user preferences and context sensitivity are likely to vary across regions by small margins, although similar combinations may play a role in determining user-merchant transactions. Thus residual learning is applied to adapt the context transformation layers and enable user preference variations.

Hadamard Scaling—Embodiments may maintain embedding consistency across domains of recommendation. Note from earlier equations that both the transformed user [symbol] and item embeddings [symbol] are obtained via element-wise combinations with the transformed context cⁿ. Thus to maintain dimensional consistency, the scaling method may be restricted to Hadamard-based transforms. Effectively, the permits different dimensions to be re-weighted but not to be changed, e.g., the semantics of dimensions are consistent though their importance may vary depending on the domain.

Adversarial Learning for Distributional Regularization—distributional regularization may be an issue of cluster-level consistency across domains. While the residual shifting and Hadamard scaling of embeddings ensure flexible adaptation, it may be necessary to maintain the same broad overall set of user and merchant clusters. Note that one distinction between conventional systems and embodiments of the present disclosure may include that embodiments of the disclosure may not restrict the joint distribution of users with varying preferences, but rather the conditional, e.g., given a user has a certain preference which matches that of some set of users in the source domain, her embedding representation matches the corresponding cluster or dense patch of the source embedding space. Applying regularization ensures smooth transfers of cross-cluster mapping while also smoothing (regularizing) noisy embedding spaces in sparse domains.

5.2 Adaptation Via Residual Learning

This subsection describes the residual adaptation of each context transformation layer. In the most general form (since there are multiple approaches to perform multi-linear context pooling), cⁿ=fⁿ(θ_{c}ⁿ⁻¹, Θ_{c}; cⁿ¹)

where θ_{c}ⁿ⁻¹ denotes the layer specific parameters of the n−1^{th} layer while Θ_{c} denotes the parameters shared by all transform layers, such as the Hadamard memory vectors [symbol] ₖ.

To enable lateral scaling across many domains or regions, it is useful that embodiments do not alter the core layer parameters, since this would result in a model-space explosion. Rather some embodiments may only perturb the model transforms with a domain-specific residual function.

Consider the above layer transformation for cⁿ, some embodiments may not modify the source-learned parameters θ_{c}ⁿ,Θ_{c} (denote the source domain by [symbol] and the target domain by [symbol] ). Embodiments may learn a target specific residual function δ_{f}ⁿ n corresponding to the n^{th} layer as a function of the layer transformed output fⁿ. Thus the adapted version is as follows,

cⁿ=fⁿ(θ_{c}ⁿ,Θ_{c};cⁿ⁻¹)+δ_{f}ⁿ(fⁿ(θ_{c}ⁿ⁻¹,Θ_{c};cⁿ⁻¹))

Note that context shortcut connections are not modified in the adaptation process. Shortcut connections of the form cⁿ⊕g(c) should be interpreted as part of the source-learned transform, e.g.,

cⁿ=fⁿ(θ_{c}ⁿ⁻¹,Θ_{c};cⁿ⁻¹,c

and provided as input to the residual function δ_{f}ⁿ.

The form of the residual function is flexible, embodiments may choose a line layer of the form W_{δ}ⁿx. A residual perturbation need not be learned for each context transform layer, rather an intuitive choice can be made to tradeoff the complexity of residual function δ_{f}ⁿ against the number of such additions.

The following are two embedding transform equations responsible for organizing the target user and merchant embedding spaces,

[symbol]

=eᵤ⊗cⁿ

[symbol]

=eᵢ⊗cⁿ

Hadamard scaling and shifting operations are applied to the feedforward layers on [symbol] , [symbol] which jointly compute the outputs [symbol] ² and [symbol] ² respectively. The residual shift is identical to the context residuals and can be applied to one or both feedforward outputs [symbol] . The Hadamard transform requires an additional scaling vector w_{⊗}ⁿ. The overall transform is as follows—

[symbol]

=σ( [symbol] ( [symbol] ⊗w_{⊗}ⁿ)+ [symbol] )+δⁿ(⋅)

5.3 Distributionally-Regularized Residual (DRR) Learning

Note that the task of maintaining cluster-level consistency across domains may be a one-class classification task, where the set of dense patches or regions in the source domain constitutes the class of interest, while the transformed embedding representations of the target domain are required to occupy or be present in proximity to one or more of these source regions. In the past, generative adversarial training has proven hugely successful at learning and imitating source distributions resembling the latent space. However, these models are trained jointly with both the source and target embeddings. In many cases, however, this is not a scalable solution. It may be difficult or impossible to train each target domain (which could number in the hundreds) with the dense source domain. Thus embodiments may train a distributional regularizer once on the source and freeze the learned regularizer prior to its application to target domains.

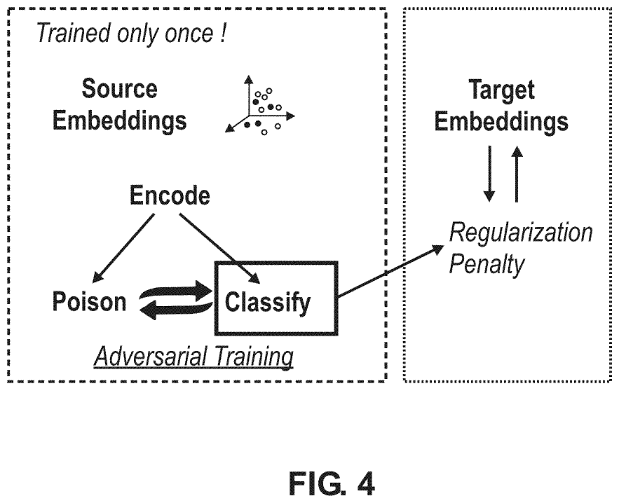

FIG. 4 illustrates an example of efficient distributional regularization in accordance with various embodiments. Some embodiments may be used to train an adaptive discriminator that anticipates the hardest examples in each target domain without accessing the actual samples. In past work, a similar challenge was considered in image classification. Embodiments of the present disclosure may provide a novel adversarial approach to learn a universal structure regularizer, which is then applied to each target at adaptation time, as illustrated in FIG. 4. First, an encoding layer serves to reduce the dimensionality of the source embeddings and identify the representative dense regions in the source domain. Next, embodiments may incorporate an explicit poisoning layer which learns to generate hard examples that mimic the source embeddings but differ by a small margin. This margin is adaptively reduced as training proceeds to learn precise demarcations of the dense source patches. Finally, the encoder is incentivized to the true source samples to an apriori reference distribution (such as [symbol] (0,1)) in the encoded latent space. A penalty is levied on the encoder for failing to t source samples to the reference distribution or for encoding negative target samples too close to the reference distribution. Thus, embodiments of the disclosure help to maximize latent space separations.

Some embodiments may employ a variational encoder ε with RelU layers, which attempts to fit the source embeddings to the referenced distribution [symbol] (0,1) in a lower dimensional space. Embodiments may help to enable ε to anticipate noise or outlier regions encountered in the target domains and penalize them. Towards this goal, the model attempts to diverge the outliers away from the reference distribution [symbol] (0,1). Thus the encoder objective is given by,

$${𝒪}_{ɛ} = KL ( N \vert ( 0 , 1 ) ) - KL ( P \vert ( 0 , 1 ) )$$

$${θ}_{ɛ} = argmax {𝒪}_{ɛ}$$

$$θ$$

The poisoning model or corruption model follows directly from the above, it adds residual noise to the positive class to produce negative samples. Further, these negative samples may confuse the Variational Encoder and hence minimize KL divergence from the reference distribution [symbol] (0,1). The negative class is generated as follows—

N=P+δP

where δP=C(P). The corruption model is trained with the following objective, aiming to confuse the encoder into placing poisoned samples in the reference distribution,

$${θ}_{c} = argmin {𝒪}_{ɛ} ( N = P + C ( P ) \\ θ$$

An important inference is that the training process may result in the corruption model learning to produce low magnitude noise. Some embodiments may explicitly penalize such an outcome—

θ_{c}=argmin(θ_{ε}−log∥C(P)∥)

As a result the corruption model is incentivized to discover non-zero solutions to corrupt the positive (or source) embeddings.

A note on overfitting to small training datasets: A long-standing challenge in machine learning is the generalization aspect for models that are trained on relatively small volumes of data. In meta-learning this problem appears in the context of model adaptation. Models adapted to very small datasets can fit noise to the base learner and thus fail to generalize well. Embodiments of the disclosure may provide an adversarial distribution regularizer as a solution to this challenge, since the fundamental receptive regions in the source domain are leveraged to maintain a similar overall structure in the target embedding space. Embodiments of the disclosure thus avoid undesirable perturbations that may result from over-fitting to noisy transaction data.

Recommendation System Example

In one particular example (simplified for the sake of illustration), the system may first train model for a dense region, using the following as input.
Users—U1, U2, and U3
Restaurants—R1, R2, R3, and R4
Transactions (User, Restaurant, Price, Restaurant Cuisine) [showing limited features]:
   U1, R1, $$, Lunch, Asian
   U1, R2, $, Lunch, Fast-food
   U1, R4, $$$, Dinner, Italian
   U2, R3, $, Lunch, Fast-food
   U2, R4, $$, Dinner, Italian
   U3, R3, $, Dinner, Fast-food

As a result of the training, the system produces the following three outputs:

1. User Embeddings:

| | | | |
|---|---|---|---|
| a. | U1 - 0.1 | 0.5 | 0.6 |
| b. | U2 - 0.1 | 0.4 | 0.5 |
| c. | U3 - 0.5 | 0.3 | 0.8 |

2. Restaurant Embeddings.

| | | | |
|---|---|---|---|
| a. | R1 - 0.2 | 0.6 | 0.8 |
| b. | R2 - 0.4 | 0.6 | 0.8 |
| c. | R3 - 0.4 | 0.6 | 0.8 |

3. Trained Model

Next, the system learns the embeddings and trains the model for a sparse region. In this process, the system uses the trained model described above, and use restaurants, users, and transactions from the sparse region. Accordingly, the system has the following as input in this example:
Users—U4 and U5
Restaurants—R5 and R6
Transactions (User, Restaurant, Price, Restaurant Cuisine):
   U4, R5, $$, Lunch, Indian
   U4, R6, $$, Dinner, Indian
   U5, R6, $, Lunch, Fast-food

As an output the system generates the following:

1. User Embeddings.

| | | | |
|---|---|---|---|
| a. | U4 - 0.3 | 0.5 | 0.7 |
| b. | U5 - 0.2 | 0.5 | 0.8 |

2. Restaurant Embeddings.

| | | | |
|---|---|---|---|
| a. | R5 - 0.2 | 0.6 | 0.8 |
| b. | R6 - 0.4 | 0.6 | 0.8 |

3. Trained Transfer Layer

Finally, the system may perform an inference process. For example, suppose the system wants to rank the restaurants in the sparse region for the user U4. Here, the system provides the embeddings for the user U4 and restaurants R5 and R6 along with the context (e.g., lunch), to the trained model. The trained model outputs the scores for the restaurants as shown below:
R5—0.67
R6—0.24

The top-k (k being a predetermined number of listings) restaurants sorted by the score may be provided to the user's computing device as recommendations.

### 6 EXPERIMENTAL RESULTS

In this section, experimental analyses are presented for various examples of embodiments of the present disclosure. For example, some model are used on multiple datasets with very diverse characteristics The datasets and baseline methods are introduced in Section 6.1, followed by the dense-source recommendation task and meta transfer gain results on sparse target domains in Section 6.2, Section 6.3 respectively, and qualitative interpretation of findings in Section 6.4. The scalability and robustness of the approach is discussed in Section 6.5, and finally future directions discussed in Section 6.6.

6.1 Datasets and Baselines

Some embodiments were tested over two publicly available datasets, Yelp and Google Local Reviews for benchmarking and reproducibility purposes. Each of the two datasets provide direct and inferred contextual features corresponding to each explicit rating by an user for a business across multiple states in the U.S. and Canada. Testing also demonstrates an example of an embodiment on a large-scale financial transaction dataset obtained from a major global payments technology company (this disclosure refers to this dataset as FT-Data). The transaction dataset is partitioned across states in the U.S., similar to the previous datasets. Each state constitutes a domain in these experiments. It is assumed no overlap between their user and item sets. The relaxation of the overlap assumption is useful for FT-Data since only ≤0.02% users appear across two or more U.S. states. Note that financial transactions in FT-Data provide implicit feedback to user spending behavior, unlike the explicit rating feedback scenario in the two other datasets. Across all three datasets, it is observed that significant performance gaps across domains (states) owing to large variations in the volume, density, and quality of the available interaction data.

This section discusses the performance of models trained independently on the individual domains in each dataset (referred as source-trained or target-only models for the dense source and sparse target states respectively), and the ability to bridge their performance gaps via meta transfer.

Google Local Reviews Dataset: This dataset contains user reviews about businesses with contextual features annotated to each 0-5 rating. The system extracts temporal, spatial, and textual context for each review, including inferred features such as user's preferred business locations on weekdays vs. weekends, average pairwise distances of these businesses, and preferred product categories grouped by businesses and users. The same set of context features are extracted for each state.

Yelp Challenge Dataset: The Yelp challenge dataset contains user reviews for businesses, e.g., restaurants across different geographic regions. The context features are similar to the Google Local dataset with a few additions, such as busy and non-busy restaurant hours inferred via user check-ins, restaurant attributes (such as accepts-only-cash), etc. The system extracts the same set of context features for each state.

FT-Data: This large-scale financial transaction dataset obtained from a major global payments technology company contains credit/debit card payments made to restaurants by cardholders in the U.S. Each transaction entry is accompanied by contextual information such as date, time, amount, etc. Unlike the public datasets, the transactions do not provide explicit ratings. The system may infer a number of contextual attributes for each cardholder-merchant interaction transaction such as weekday vs. weekend, lunch vs. dinner, tipping amount, etc. The system may also leverage cardholders' and merchants' transaction history and infer additional contextual features such as the spending habits of users, restaurant popularity, restaurant peak hours, cardholders' tipping patterns at restaurants, etc.

The system pre-processes Google Local and Yelp datasets to retain users and items with at least 3 or more reviews, and at least 10 or more reviews respectively. FT-Data was filtered to include transactions involving cardholders having at least 10 and merchants having at least 20 transactions in a 3-month period. For each dataset, the system chooses a region with high-volume (e.g., high total number of interactions) and high-density (e.g., high total number of interactions with businesses per user) as the dense-source and multiple sparse-target states with low interaction volumes and low densities as candidates for meta transfer from the source. Dataset details are shown in Table 2. Context features are normalized to the 0-1 range with normalization applied separately to each state in each dataset.

TABLE 1
Comparing aspects addressed by baseline
models against proposed MMT-Net approach

| | Bi-Linear | Multi-Linear | Low- | Factor | |
|---|---|---|---|---|---|
| | Pooling | Pooling | Rank | Weights | Θ(Context) |
| NFM | Yes | No | No | No | Quadratic* |
| AFM | Yes | No | No | Yes | Quadratic |
| AIN | | | | | |
| FMT | | | | | |
| MMT | Yes | Yes | Yes | Yes | Linear |

TABLE 2
Source and Target statistics for each of the datasets

| Dataset | State | Users | Items | Interaction |
|---|---|---|---|---|
| | Bay-Area CA(S) | 1M | 9K | 25M |
| FT-Data | Arkansas (T₁) | 0.4M | 3K | 5M |
| | Kansas (T₂) | 0.35M | 3K | 5.1M |
| | New-Mexico (T₃) | 0.32M | 2.8K | 6M |
| | Iowa (T₄) | 0.3M | 3K | 4.8M |
| | PA (S) | 10.3K | 5.5K | 0.17M |
| Yelp | Alberta, Canada (T₁) | 5K | 3.5K | 55K |
| | Illinois (T₂) | 1.8K | 1K | 23K |
| | South Carolina (T₃) | 0.6K | 0.4K | 6.2K |
| | California (S) | 46K | 28K | 0.32M |
| Google Local | Colorado (T₁) | 10K | 5.7K | 51K |
| | Michigan (T₂) | 7K | 4K | 29K |
| | Ohio (T₃) | 5.4K | 3.2K | 23K |

For each dataset, the system trains the recommender system on each state in isolation. When each model is trained and tested on its own state, the source-trained model significantly outperforms the target-only models. The system compares the source model performance against state-of-the-art baselines, and demonstrates the effectiveness of the proposed context transform model. The system also experimentally validates that the learned transforms are generalizable and extensible to the target states. The baselines are:

NCF: State-of-the-art non context-aware model for comparisons and context validation.

CAMF-C: Augments conventional Matrix Factorization to incorporate a context-bias term for item latent factor. This version assumes a fixed bias for a given context feature for all items.

CAMF: CAMF-C with separate context bias values for each item. This version is used for comparisons.

MTF: Obtains latent representations via decomposition of the User-Item-Context tensor. This model scales very poorly with the size of the context vector.

NFM: Employs a bilinear interaction model applied to the context features of each interaction for representation.

AFM: Incorporates an attention mechanism to reweight the bilinear pooled factors in the NFM model. This method is significantly slower than NFM and is limited by number of factors.

AIN: Employs an attention mechanism to reweight the interactions of user and item representations with each contextual factor. However, this does not consider their pooled combinations.

MMT-Net (Embodiment of this disclosure): The model of the present disclosure is referred to as the Multi-Linear Meta Transfer Network (MMT-Net).

FMT-Net (Variant): To demonstrate the importance of the multi-linear interaction model for context, context transform is replaced with an equal number of feed-forward layers.

MMT-Net Multimodal (Variant): To enhances the attributional, historical and transactional context features, another embodiment of the disclosure provides a model with a multi-modal degree of freedom. (Section 4.2).

Once the source model is trained, the meta transfer approach is evaluated by measuring the gains obtained on each sparse target domain. The meta transfer performance of the embodiments of the present disclosure are compared against the following baseline meta-learning approaches.

LWA: Proposes a user-level meta learned model, where each user's history is combined with a new item. The user history is a linear combination of his positive and negative classes, with weights learned for each user.

NLBA: Similar to LWA. However, this uses a neural network instead of a linear model, and the layer biases are learned for each user separately.

s²-Met: Poses the meta-problem of learning to instantiate and train a recommender on different scenarios. Scenarios are presented as combinations of context values in each dataset.

DRR—Distributionally Regularized Residuals (Approach of Embodiments of the present disclosure): This approach is to adapt source-model layers via residual learning on each target domain.

Direct Layer Transfer (Variant): This approach uses pre-trained user and item embeddings of each target model with the source layers and is used to demonstrate direct compatibility of the learned models.

Annealing (Variant): This approach follows an annealing schedule for the transferred layers to adapt them to the target domain.

This disclosure proceeds by interpreting the recommendation results obtained by fitting models independently on the dense source and sparse target states in each dataset.

6.2 Recommendation Task

The system randomly splits each dataset into Training (80%), Validation (10%) and Test (10%) subsets. The system tunes all baseline models with parameter ranges centered at the author provided values, to optimize performance on the datasets. For fair comparison, the system sets the user and item embedding dimensions to 150 for all recommendation models.

For the implicit feedback setting in FT-Data, the system employs evaluation metrics. For each test-sample, 100 negative samples were drawn, where 50 negative samples draw a random negative merchant while holding the same context values, while the other 50 randomize the context values while holding the merchant the same. Thus the model of the present disclosure is evaluated on its ability to both: predict the right merchant given the context, and to predict the right context given the merchant. To evaluate the performance of the recommender models listed above, the system computes the average Hit-Rate@K(H@K) metric. The system evaluates each ranked list at K=1, 5 (Table 3). The Hit-Rate value measures the percentage of test-samples where the positive sample was ranked in the top-K entries.

For the explicit feedback setting in the Google Local and Yelp datasets, the system employs the RMSE and MAE metrics to measure the deviation between the true rating and the value predicted by each recommendation model (Table 4). Note that no negative samples are required for the explicit feedback evaluation, the same holds true for rating model training as well.

6.2.1 Comparative Analysis:

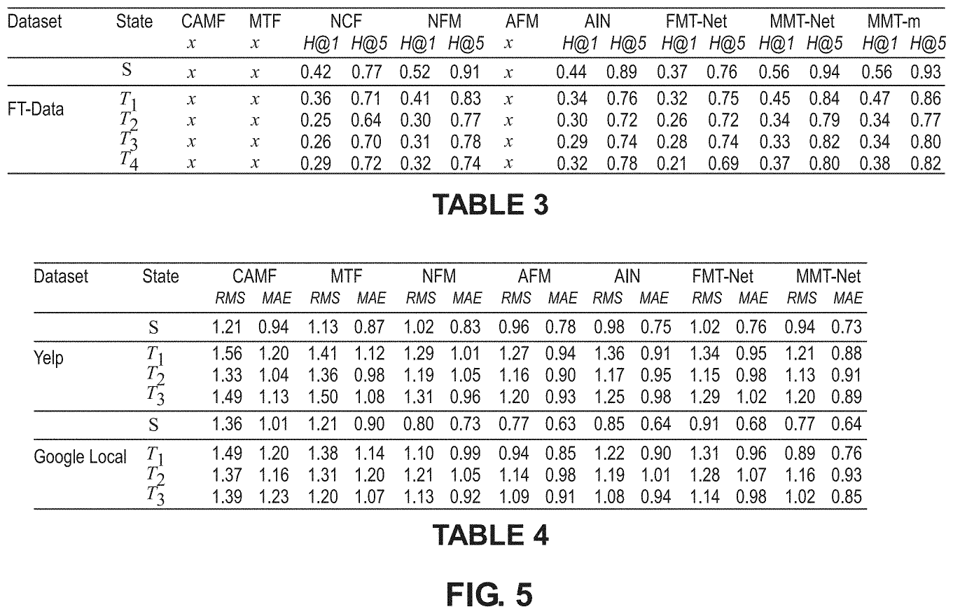

FIG. 5 illustrates two tables (Table 3 and Table 4) showing that several observations can be made from the experimental results obtained with the baseline recommenders and the FMT-Net and MMT-Net variants (Table 3, Table 4). NFM is linear in pratice owing to a simple algebraic re-organization and thus scales to larger datasets, while AFM fails to do so (Table3).

In particular, Table 3 in FIG. 5 shows source and target region performance values across baselines and model variants of the present disclosure when trained in isolation (e.g., no transfer), while x indicates the recommender model either timed out or ran out of memory. All models and domains are evaluated on H@1, H@5 metrics for the implicit feedback scenario. Note that NDCG may not be a meaningful metric in models of the present disclosure, since there is only one positive sample in each ranked list.

Table 4 in FIG. 5 is the same as Table 3 for the explicit feedback scenario. All models and domains are evaluated on the RMSE, MAE metrics for the explicit feedback scenario against ground-truth ratings. Baseline models were adapted for explicit feedback either by incorporating learned user, item, and global bias parameters, or by scaling down rating values to the 0-1 range where required.

This disclosure proceeds by discussing the most relevant features of the baselines and the variants of embodiments of this disclosure in Table 1. Note that the methods with some form of context pooling significantly outperform methods that do not consider pooled factors. Also note the stark difference in the FMT and MMT model performance, demonstrating the importance of the pooled multi-linear formulation. These performance differences are more pronounced in the implicit feedback setting (Table 3). A probable cause is the greater relevance of transaction context (e.g., review time is just a proxy to the user's likely visit time, while transactions can provide more accurate temporal features) and larger number of context features in FT-Data vs Google Local and Yelp (200 vs 80,90), magnifying the importance of feature pooling for FT-Data.

6.2.2 the Importance of Multi-Linear Expressivity:

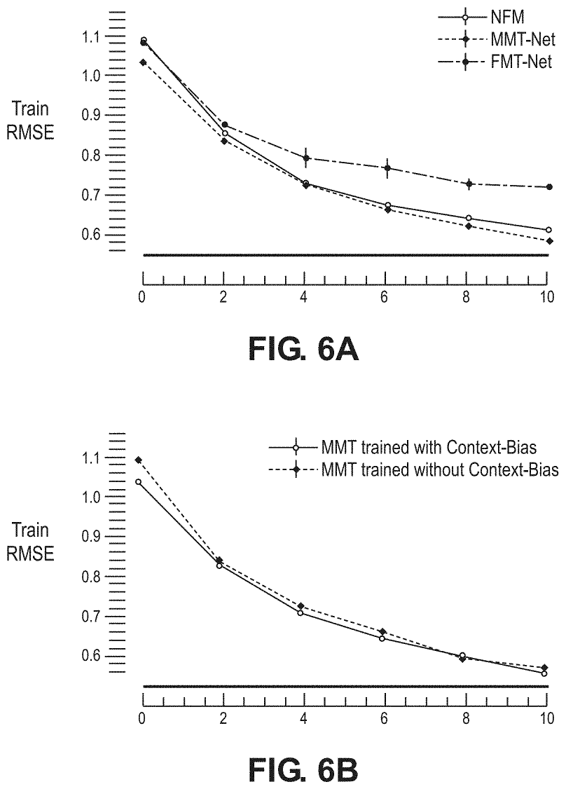

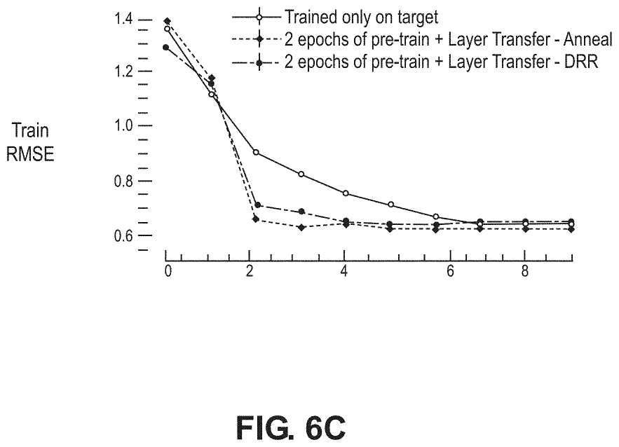

To further analyze the performance gains achieved by context pooling models, observe the convergence of the MMT, FMT and NFM recommender models on the source domains of FT-Data and the Google Local dataset, as illustrated in FIGS. 6A-6C. In particular, FIG. 6A illustrates the Train-RMSE values of models incorporating context pooling converges faster and to a lower Train-RMSE value, indicating their grater expressivity and ability to fit the training data. FIG. 6B illustrates that the Train-RMSE values of MMT trained with and without context bias on the Google Local California source state are nearly identical. FIG. 6C illustrates the Train-RMSE values of MMT-Net with target-only training (Google Local Colorado target), and when annealed/residual-fitting after 2epochs of pre-training, with models generated by an embodiment of the disclosure providing superior results to the target-only model with significantly less computational effort.

As shown in FIGS. 6A-6C, the lack of pooled expressivity in the FMT model impacts the learning process, demonstrating the importance of context intersection. The NFM and MMT models converge faster, reach lower Train-RMSE values, and outperform FMT on the test data (Table 3, Table 4). It may also be observed the attention based model AIN (also an additive model) is outperformed by models incorporating pooled factors, although the test performance gap is less pronounced in the smaller review datasets (Table 4).

6.2.3 Training without Context-Adaptive Variance Reduction:

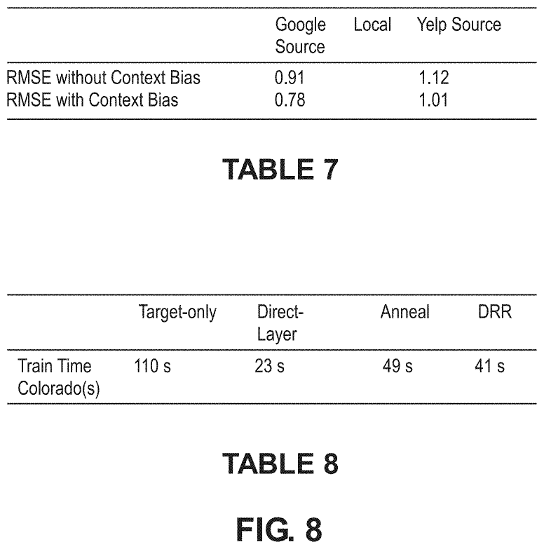

To understand the importance of variance reduction via pooled context in the training process, the above analysis is repeated for the MMT-Net model with and without the adaptive context bias term in the training objective (Section 4.3). The performance results are detailed in Table 7, shown in FIG. 8, which illustrates MMT-Net performance when trained with and without the context bias term.

As shown in Table 7, there is a massive gap in the Test-RMSE, although this does not reflect in the training process (Section 6.2.2). The most probable explanation is that the model overfits the user and item bias terms (Section 4.3) in the absence of the adaptive context bias, and thus achieve similar Train-RMSE. However, these user and item specific terms are not robust or generalizable since they are completely independent of the transaction context which is shared across recommendation domains.

6.3 Meta Transfer to Sparse Target States

The performance and scalability/training-time gains obtained in by transferring the source model (MMT-Net architecture fitted to source) to targets through the Meta Transfer approaches are presented, and compares results to applicable prior meta-learning literature for recommendation.

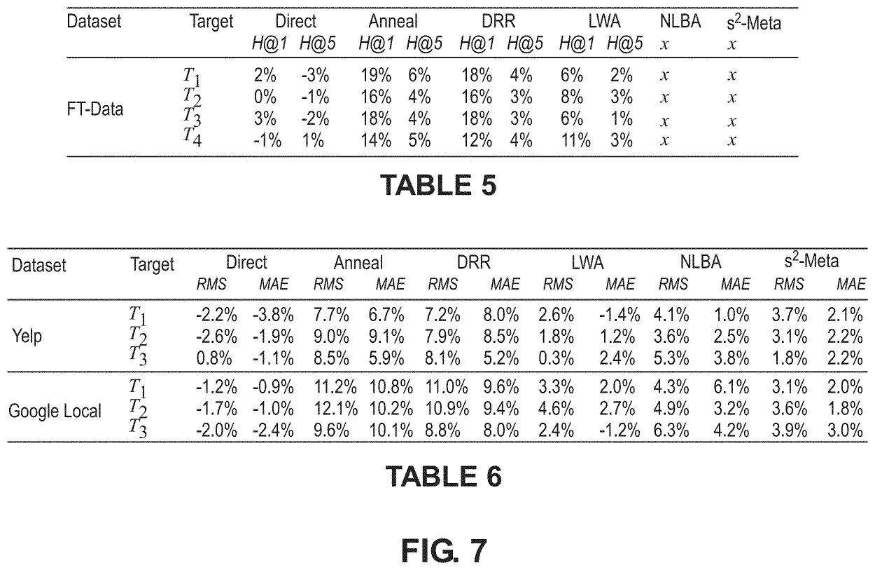

Table 6, shown in FIG. 7, demonstrates the reductions in RMSE and MAE as a result of meta learning (Google Local, Yelp). In particular, Table 6 illustrates improvements over Table 4 (shown in FIG. 5) for each target domain applying the meta-learning baselines and the meta-transfer approaches of the present disclosure from the source domain. In Table 6, all models are now evaluated by the percentage drop in the RMSE, MAE metrics for each target domain (e.g., since less is better). Direct layer-transfer is a minor degradation in contrast to the target-only model (with multiplicative computational gains on each target domain), demonstrating the effectiveness of the multi-linear contextual invariants.

Table 5, shown in FIG. 7 demonstrates significant improvements in the hit-rates (FT-Data) for both K-values (although there is less scope for improvement for larger K-values since the ranked list is only 101 entries long). In particular, Table 5 shows percentage improvements over Table 3 for each target domain in FT-Data applying the meta-learning baselines and meta transfer approaches of the present disclosure from the source domain. Note that in Table 5, direct layer-transfer performs virtually the same as the target model, indicating dimensional-uniformity induced by embodiments of the disclosure across recommendation domains, and an “x” indicates an inability to scale the meta-learning process to the datasets. This starts with an analysis of the training process for Annealing, Distributionally Regularized Residual (DRR) Adaptation compared to target-only training.

On each target dataset, the MMT-Net model is pre-trained for 2 epochs. All model layers are then replaced by the Source model, however the user and item embeddings are retained as they are, followed by annealing or DRR. It can be observed the training loss curves for the largest target state in the Google Local dataset as shown in FIG. 6C.

As shown, there is a significant reduction in the training time and computational effort, since Anneal and DRR adaptation converge in one and two epochs respectively when applied to the pre-trained target model, and outperform 10 epochs of target-only training by Significant margins (Table 6 in FIG. 7). The total training times (including the pre-training of the source model for DRR and Annealing) of the compared methods are listed in Table 8 in FIG. 8. In particular, Table 8 illustrates the total MMT-Net training time on Google Local target state Colorado with target-only, and annealing/DRR with two epochs of pre-training. Direct layer-transfer loses 0.1 RMSE points vs. target-only with a fifth of the train time.

As shown, direct Layer-Transfer pre-trains the target model for two epochs and transfers the model layers learning on the source, with relatively small degradations in Test-RMSE vs. the ten epoch target-only models (Table 6). These computational gains are especially impactful as the number of target domains to which the model is transferred are increased, one important advantage of embodiments of the present disclosure.

This disclosure proceeds by highlighting some observations.

Review-Data vs FT-Data—The effects of context-pooling are more pronounced in FT-Data. A probable cause is the greater number (220 vs 90) and quality of contextual features.

Inconsistency across states—The size and density of the target datasets are not always correlated to the gains achieved upon transfer, skew (e.g., few towns vs one big city) and other data factors play a significant role. For simplicity, target domains were aggregated by state, although it may be expected that a finer resolution (such as town) would yield better transfer performance.

Direct Layer-Transfer—The effectiveness of direct layer-transfer is a practical metric for the quality of the inferred contextual invariants.

Annealing is a strong adaptation method, but it produces a separate model for each target domain. It may be important to avoid training multiple models, especially when training a finer target granularity as highlighted in the above observations.

The disclosure proceeds by qualitatively analyzing the results to interpret the source of the performance gains for embodiments of the present disclosure.

6.4 Interpreting Performance Gains

The disclosure proceeds by first analyzing models of the present disclosure from the model training and convergence perspective for the Meta Transfer methods. It may be observed that consistent trends across the direct Layer-Transfer, Anneal and DRR adaptation approaches exist. The Volume-Density perspective provides clues to target states and their user sub-populations where the transfer method produces the most noticeable performance gains. Volume, Density and Interaction skew across users and items, all play a role in the effectiveness of Meta Transfer. Finally, this disclosure discusses the embedding structure of the source model and DRR adapted sparse target model, and thus plots the TSNE visualizations of the user embeddings of the Google Local California source model and the Colorado target model when DRR adapted from the California source model.

6.4.1 Model Training and Convergence Analysis.

The following highlights a few consistent observations across datasets, and target domains:

The target-only model takes significantly longer to converge to a stable Train-RMSE in comparison to the Anneal and DRR adaptation methods (10 epochs vs 2 pre-train epochs+1-anneal/2-residual). Although the final Train-RMSE appears similar for these two methods (FIG. 5), there is a significant performance difference between them on the test dataset. This indicates that training loss alone is not indicative of the final model performance and the target-only training method likely observes lower Train-RMSE by overfitting to the sparse data.

Direct layer-transfer is a reasonable alternative to the target-only model (Table 6), essentially entailing one-fifth the training cost (2 pre-training epochs vs 10 target-only epochs). This also indicates the generalizability of the contextual invariants learned on the source dataset, since it is directly applied to the target pre-trained embeddings.

DRR is a strong alternative to the Annealing approach, although there is a small performance gap on most target states (Table 6). The primary advantage of DRR is the need to just store a small number (in this case 3) of strategically placed residual layers for each target region, while the source model is left unchanged. DRR could also be investigated towards temporal updates to the source model for evolving user preferences.

6.4.2 the Volume-Density Perspective.

In this section, the disclosure identifies the sub-populations of users who benefit the most from meta transfer by varying two key parameters—Volume (total number of interactions) and Density (interactions per user) in the training set and t models to each training set separately. The system then meta transfers the source model to each of these training sets and observes the gains achieved in their final performance.

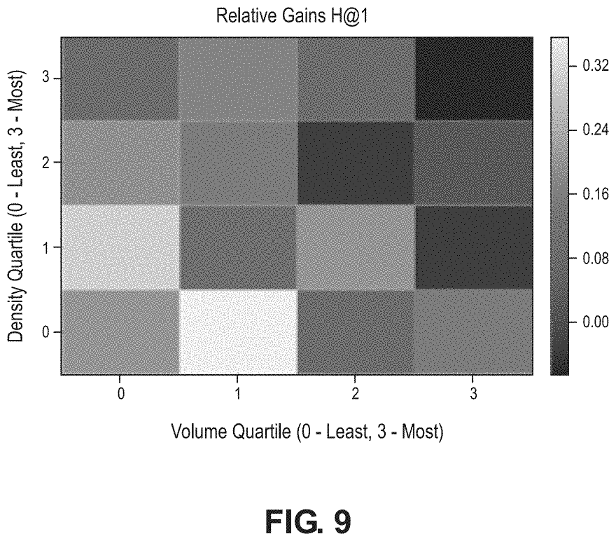

To vary the density and volumes of the target data, the system may remove varying proportions of sparse or dense users from the dataset, thus controlling for both the average volume and density. Models can be trained separately to these modified training sets, and observe the gains achieved with Meta Transfer from the source domain for each one. The results on the largest target state in FT-data, Arkansas, is demonstrated in FIG. 9. In particular, FIG. 9 demonstrates the relative percentage improvement in the H@1 performance across different Volume-Density subsets of the Arkansas target, FT-Data.

FIG. 9 indicates strong gains in the lower-half and left-half of the heat map (low-density, low-volume). Sparse users are benefited by a generalizable and effective context transform learned on the much larger source domain, where there is sufficient training data to infer the most important context factor associations (with the multi-linear formulation).

6.4.3 Embedding Visualization.

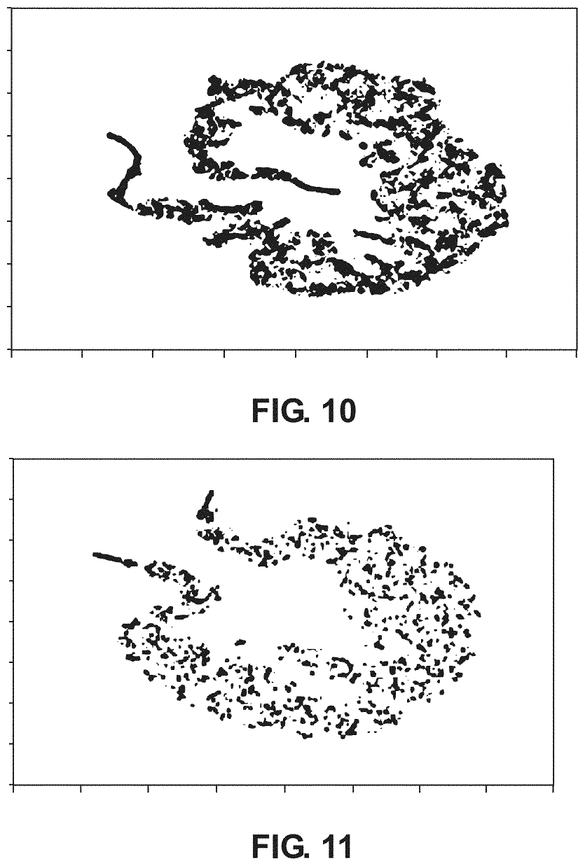

The Distributionally Regularized Residual (DRR) strategy of the embodiments of the present disclosure helps ensure structural consistency in the transformed user and merchant embedding spaces, thus enabling the learned associations to be applied to the target domain. To validate this hypothesis, the user embedding structure across the Source (California) and the largest target domain(Colorado) in the Google Local Dataset, after applying the DRR strategy for adaptation may be reviewed as shown in FIGS. 10 and 11. In particular, FIG. 10 illustrates a 2D TSNE visualization of the Google Local California (source state) user embedding space. FIG. 11 illustrates a 2D TSNE visualization of the Google Local Colorado (Target) user embedding space after meta data transfer via DRR.

As shown in FIG. 10, the California embedding space has a distinct spiral clustering structure, with many locally dense regions, reflecting different types of users. A very similar structure is observed in the Colorado embedding space in FIG. 11 as well, after adopting the DRR strategy of the present disclosure. Note that the user embeddings in each space are represented via 2-dimensional TSNE visualizations.

6.5 Scalability and Robustness Analysis

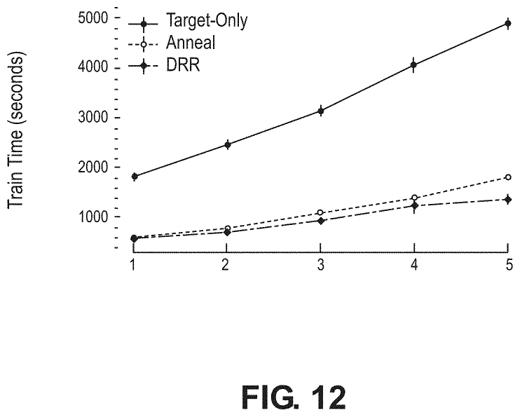

The scalability of meta-transfer according to embodiments of the present disclosure is demonstrated with the number of transactions in the target domain in FIG. 12 against training separate models. In particular, FIG. 12 illustrates training time for the target-only, anneal, and DRR approaches against millions of interactions (with a user interaction density of 10).

The previous observations in Section 6.3 validate the ability of the models of the present disclosure to scale with a greater number of target domains, and finer resolution for selection of targets, while source training is a one-time expense. This also enables embodiments of the present disclosure to scale complex architectures and transformations in comparison to black box latent models that are not readily amenable to reuse.

The experimental data further demonstrates the robustness of embodiments of the disclosure to missing context features, by randomly dropping up to 20% of the context features describing each transaction, in train and test time for both, the source and target states in Table 9 below.

TABLE 9
MMT-Net performance degradation was measured by decrease
in HR@5 or increase in RMSE, averaged over target
states with random context feature dropout

| Context Drop | 5% | 10% | 15% | 20% |
|---|---|---|---|---|
| FT-Data | 1.1% | 2.6% | 4.1% | 6.0% |
| Google Local | 3.9% | 4.2% | 7.0% | 8.8% |
| Yelp | 1.8% | 3.2% | 5.4% | 7.3% |

6.6 Discussion

Some models presented herein are dependent on the presence of shared or semantically similar context between the source and target domains. Additionally, some models presented herein may not extend to the case where a significant number of users or items are shared across recommendation domains. The embeddings and learn-to-learn part may be separated, which improves modularity, but prevents direct reuse of representations across domains. Since only the transformation layers are shared. Depending on the application, context features can be picked to enhance social inference and prevent loss of diversity in the general recommendations.

As noted above, embodiments of the present disclosure may be used in conjunction with recommendation systems for a wide variety of applications. One such application includes a global personalized restaurant recommendation (GPR) system, which may be implemented using any of the systems described above in FIGS. 1A and 1B. In some embodiments, the GPR does not use any explicit reviews or ratings or domain-specific metadata, but rather leverages financial transactions to build user profiles for over cardholders from a number of ountries and restaurant profiles for in cities worldwide.

In some embodiments, the GPR being a global recommender system needs to account for the regional variations in people's food choices and habits. These and other issues may be addressed by embodiments of the present disclosure by combining three different recommendations algorithms, as opposed to using a single revolutionary model in the backend. The individual recommendation models are not only scalable, but also adapt to varying data skew challenges in order to ensure high-quality personalized recommendations for any user anywhere in the world.

In some embodiments, the GPR returns personalized restaurant recommendations based on previous restaurant visits by users, obtainable from payment card transactions. Like most practical personalized recommender systems, GPR's main challenges include efficiency and scalability, sparsity in user-item interactions, cold start users and items, etc.

Embodiments of the GPR system may not only be personalized but also global. A global recommendation system necessitates the recommendation engine to work for users distributed worldwide with geographically distinct tastes and food habits. The problem is even more pronounced for a global restaurant recommender system because of the following reasons. Anthropologists have observed that terrain, climate, flora, fauna, religion, culture, and genetic makeup influence people's food choices. The same cuisine (or, same dish) tastes different in different regions because of varying cooking methods and ingredients availability. Though globalization has shrunk the world, multinational food companies continue to alter their products for each country to meet consumer market needs. Accordingly, the GPR may address this geography of taste in its model. Additionally, eating at restaurants from around the world entails a user to visit the restaurant physically. This gives rise to huge amounts of skew in data.

In some embodiments, given a user's 16-digit payment card number and a query location (e.g., a city or the user's current latitude/longitude), the GPR returns a set of ten restaurants that she may like. Some of the main technical challenges for GPR are discussed below.

Data Skew: Users have a large skew in terms of transactional history, ranging from a single restaurant transaction to hundreds of restaurant transactions in six months. The skew in user transactional history is not only tied to a region but can extend across regions. A user who has a lot of restaurant transactions in her city may have very few restaurant transactions in a city she visited for vacation. Her taste while traveling may be quite different from her taste while in her hometown. Such sparsity poses a challenge in finding similar users, especially since the number of regions in the world is very high. Similar to users, restaurants also have a skew in their transactional history. Ensuring the quality of recommendations across such a wide range of transactional behavior is challenging.

Data Scale: The scale of data, e.g., the number of users, restaurants, and interactions between them, presents a lot of challenges for not only training the recommendation models but also efficient retrieval of recommendations in real-time.

No Metadata: Some embodiments of the present disclosure may leverage only financial transactions for users and basic information about restaurants (e.g., name, address). In other words, the system may not have access to any metadata for users (e.g., age) or restaurants (e.g., cuisine). The system may also not have any explicit feedback available for restaurants by users.

Quality control: In some embodiments, not all restaurants that exist in the a merchant catalog will be recommended to users. Specifically, the system may eliminate the restaurants where people eat out of convenience rather than preference, e.g., single-dollar fast food chain restaurants, office cafeterias, and airport eateries. The absence of metadata makes this elimination especially challenging.

Cold-start Users: Some embodiments may train models on cardholders who have at least one restaurant transaction during a six month period. However, the system may need to support all payment cardholders at run time, even if some are not present in the training set either because the card is new or because the user has not used it in a long time or because the user has not used it at restaurants.

Data Availability: Not all cities, states, and countries may have rich payment card transaction data, since some countries are cashbased, and some countries have domestic payment networks. Embodiments of the present disclosure may need to provide high-quality recommendations across all cities, states, and countries.

GPR systems of the present disclosure help address the preceding issues (and others) by using a combination of three recommendation algorithms instead of using a single revolutionary model in the backend to manage the data skew issue. Each model is aimed at handling different ranges of the skew. The models, in descending order of their recommendation quality and training data requirements, are: a Meta Transfer Learning Model, a Collaborative Filtering Model, and a Popularity Model.

By selecting an appropriate model at inference time based on the richness of transactional history for the user and restaurants under consideration, the GPR system helps to ensure high quality restaurant recommendations. The popularity model enables GPR to work for cold-start users and in locations where payment card transactions are limited. The GPR models may be scalable and designed to function even without any metadata about users and restaurants. GPR's data preprocessing pipeline is scalable as well, and employs quality control by eliminating restaurants that are not suitable for recommendation.

Although GPR is specifically designed for personalizing restaurant recommendations, the ideas and the framework described in this disclosure may be applied to a variety of other settings.

In some embodiments, a user may provide the system with payment card information and a location. The system uses the payment card information to obtain a profile for the user and use the location to get the list of restaurants that need to be ranked. The system will then provide a personalized ranked list. For the case when a user does not have sufficient transactional history, the results may not be personalized.

In some embodiments, to ensure the privacy of the users, GPR does not log any interaction, or data associated with the interaction with GPR may be anonymized.

GPR SYSTEM OVERVIEW: This section describes examples of the architecture of GPR according to some embodiments, which may work in two phases, specifically training and inference. GPR may utilize a predetermined period (e.g., six months) of payment card transactions in the training phase to train recommendation models and build profiles for users and restaurants. In the inference phase, GPR accepts a payment card number (a 16-digit payment card number in this example) along with a location, and uses the models and profiles, built in the training phase, to provide users with a ranked list of restaurant recommendations. These two phases are described in more detail below.

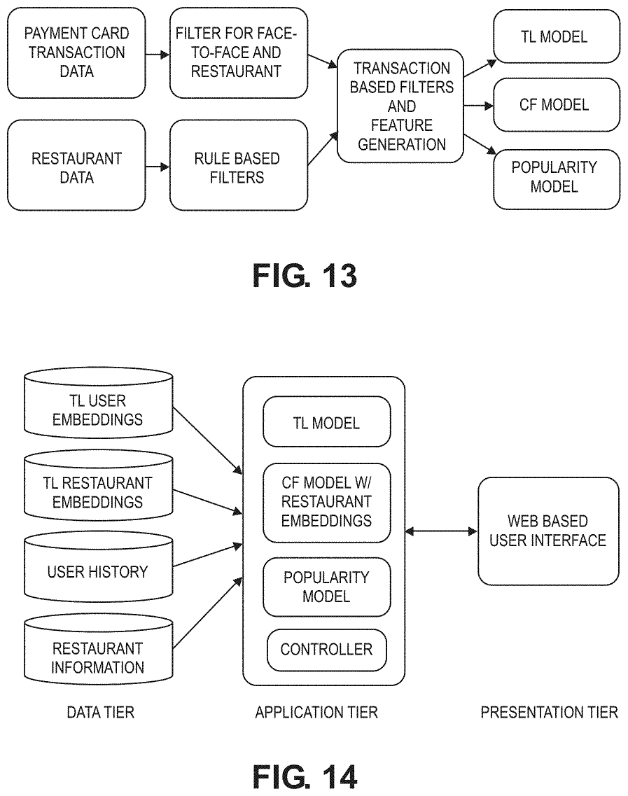

Training: FIG. 13 illustrates the data-pipeline for the training phase of GPR. The starting point of the pipeline is six months of payment card transactions, which include details like 16-digit payment card number, transaction date-time, amount, and a merchant identifier. Additionally, for the merchants, the system may have basic information such as name, address, and category. The system may use the category field to identify restaurant transactions. The first part of the data-pipeline is a set of Hive and Spark scripts that (a) read payment card transactions from Hadoop data-store, (b) join the transactions with the merchant table while selecting restaurant transactions, (c) perform rule-based and transaction-based filtering, (d) generate features and partition the data as required by the models, and (e) dump the data to flat files to facilitate the training of the models. In the second part of the data-pipeline, the system trains the respective inference models.

Specifically, the system trains the meta-transfer learning (“TL”), collaborative filter (“CF”), and popularity models shown in FIG. 13. Finally, the system saves the models in their corresponding deployable format. Additionally, the system stores the embeddings and the restaurant information in a database. Next, the disclosure proceeds by describing the components of FIG. 13.

Filters: In some embodiments, the filters may be configured to address the challenge of quality control. In particular, the system may filter out the convenience restaurants, which may be defined as the restaurants where people eat out of convenience rather than preference, e.g., office cafeteria, airport eateries, single-dollar chains. The system may eliminate convenience restaurants because they not only pollute the output of the system but also add noise to the training data, thereby degrading the recommendation models. In the absence of metadata about the restaurants, the system may take a data-oriented approach for the filtering process.

The rule-based filters use various rules and heuristics on the restaurant names. The following are some example rules that may be used: (a) to eliminate single-dollar chains, the system may filter out the restaurants with more than 3K locations across the world; (b) to eliminate airport restaurants, the system may filter out all the restaurants with an airport code within their name. For example, for the San Francisco city, the system may eliminate all the restaurants that have “SFO” in their name.

The transaction-based filters may use transactional information for identifying the restaurants to be filtered out. One such filter may be to remove the office cafeterias. The system may introduce a return-rate metric to identify office cafeterias. Return rate may be defined as the percentage of total distinct users with more than thirty lunch transactions (e.g., a weekday transaction between 11 a.m. and 3 p.m.) in six months. If the return rate is higher than 2.0, the system may identify the restaurant as an office cafeteria and consequently filter it out.

The system may choose thresholds to strike a balance between false positives and false-negatives. The system may additionally have transaction count-based filters to eliminate on-demand prepared food delivery services.

Meta-Transfer Learning Model: The meta transfer learning model is based on models described previously, which addresses the scalability and sparsity problem for recommender systems. As noted above, the recommendation systems of the present disclosure help provide an inexpensive and effective residual learning strategy that enables dense to sparse transfer for the recommender systems. In addition to addressing the skew challenge, the meta transfer learning model also addresses the scale challenge by enabling embodiments to partition the learning problem into smaller chunks that the system can train independently.

The meta transfer learning processes described herein enables the system to train computationally-heavy deep learning-based models in a scalable manner. The system may train a deep learning-based recommender model using dense data and adapt the trained model to work with sparse data. In an example, the system may start by choosing the bay area restaurants and then limit the users and restaurants to those having dense interactions between them. The system may use this dense data to train a deep learning-based base recommender model. To adapt the model globally, the system may partition the data based on states within the US and countries outside the US. The system may then adapt the base model for all the data partitions training the residuals and the embeddings (user and restaurant) on the way.

Collaborative Filtering Model: The system may use the collaborative filtering model to address the limitation of the transfer learning model while dealing with users with very few restaurant transactions. Even though the transfer learning model handles data sparsity well, when a user has very few transactions (e.g., less than 10), it may be unable to learn meaningful embeddings for the user. Thus for the collaborative filtering model, the system may not use user embeddings but rather only rely on restaurant embeddings.

For the training phase, the system may generate restaurant embeddings. To train the embeddings, the system may use a randomized sequence of user visits and feed it to a customized version ofWord2Vec that supports large vocabularies using a window of size of fifteen. By randomizing the sequence of visits and increasing the window size, the system may consider restaurants across multiple locations for the Word2Vec context, reducing the location bias within the embeddings.

Additionally, to ensure the quality of embeddings, the system may only consider the restaurants with at least two thousand transactions in six months. This filtering helps to ensure that Word2Vec sees a sufficient number of examples to build high-quality embeddings.

Popularity Model: The popularity model addresses the cold-start challenge by providing recommendations to users with no transactional history. It also helps the system to rank the restaurants for which the system does not have sufficient transactional history to learn high-quality embeddings for the transfer learning and collaborative filtering models. The popularity model is a non-personalized model that ranks restaurants based on the number of transactions.

Inference

In some embodiments, GPR may be implemented as a three-tier web application, the architecture of one example of which is shown in FIG. 14. In the example shown in FIG. 14, the database layer hosts the databases for the different embeddings and the restaurant data. The application tier includes a controller hosted on an application server and models deployed on Tensorflow serving. The user interface is a NodeJS application, which runs on a web browser, and communicates with a backend REST API. The disclosure proceeds by describing the components in FIG. 14.

Data Tier: the system may use two databases to hold all the data required by the inference models. The system may use RocksDB to store the user embeddings and the users' history for all the users. The system may encrypt 16-digit account numbers using a one-way hash. For the user information, the system may need to perform a point lookup based on the hash of a user's 16-digit payment card number. By using RocksDB for storing the user information, the system may not only reduce the latency of the application but also reduce the time taken to update the user history in the training phase. The system may use a MySQL database to store the details for all the restaurants. The system may use spatial indexes in MySQL to speed up restaurant lookups, which are based on a bounded box defined by latitude and longitude. The system may store the restaurant embedding along with the restaurant details in a single table, enabling the system to get the restaurant embedding and details in a single query.

Application Tier: The application tier includes a web application hosted on Apache Tomcat. The controller hands the bulk of the backend logic. It exposes a Rest API for the user interface to pass in a hash of 16-digit payment card number and a location in a form for a rectangular box of bounded by latitudes and longitudes. The first step towards inference is to obtain the list of restaurants that fall within the query bounded box. The restaurant selection helps reduces inference space, as the system may now need only to rank the selected restaurants.

For the next step of selecting a model of inference, the system may have a rule-based logic. One of the following cases is selected as discussed next. (A) the system may first check if there are embeddings for the cardholder. Having the user embeddings implies that the user has a rich transaction history, and the system may have a good profile for the user in terms of embeddings. In this case, the system may use the transfer learning-based model as it yields the best quality recommendation. (B) in the absence of user embeddings, the system may check for user history. Having user history indicates that the user had at least one restaurant transaction, but the history is not rich enough to learn the user profile. In this case, the system may use the collaborative filter model. The system may use the user's top-10 most frequently visited restaurants, and rank the restaurants based on how similar they are to the user's restaurants. To compute similarity, the system may use cosine distance using the restaurant embeddings. (C) If the user lacks restaurant transactions in this history, the system may be unable to personalize the recommendations. In this case, the system may use the popularity-based model and rank restaurants in the descending order of the number of transactions in six months. For cases (A) and (B), if the system is unable to rank ten restaurants, the system may fall-back to the popularity model. This happens when the system does not have restaurants with sufficient payment card transactions.

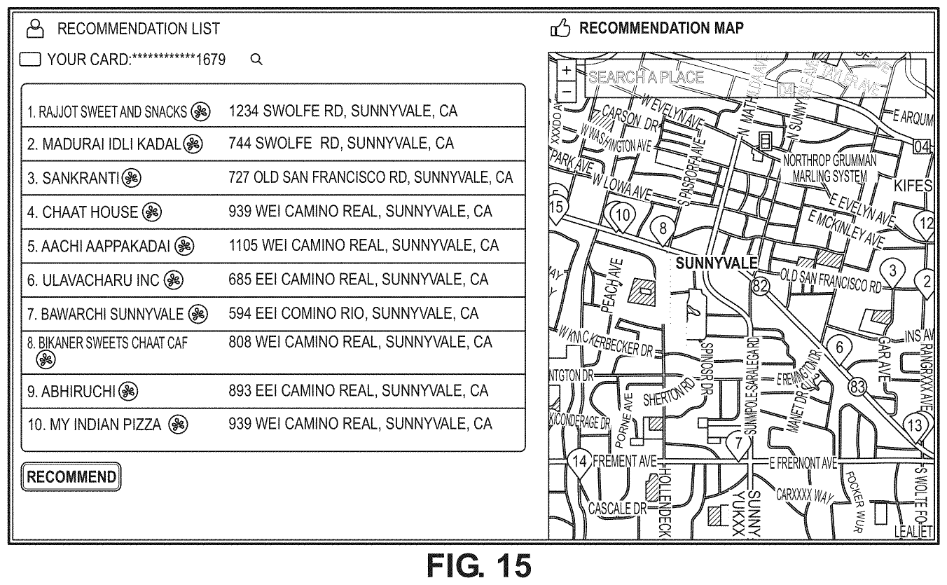

User Interface: In some embodiments, the user interface is a NodeJS application that runs in a web browser. An example of the user interface is depicted in FIG. 15. The user interface enables users to enter a 16-digit payment card number and select a location. Users may choose to either manually enter their card number or swipe the card. For selecting the location, users can either search for an address or pan and zoom in-out the map. Upon selecting a location, the user interface issues a Rest API call to the backend to obtain the recommendations. The results are displayed as a ranked list and also plotted on the map interface.

The present disclosure has been presented in accordance with the embodiments shown, and there could be variations to the embodiments, and any variations would be within the spirit and scope of the present disclosure. For example, the exemplary embodiment can be implemented using hardware, software, a computer readable medium containing program instructions, or a combination thereof. Accordingly, many modifications may be made by one of ordinary skill in the art without departing from the spirit and scope of the appended claims.

What is claimed is:

1. A computer system comprising:
a processor; and
memory coupled to the processor and storing instructions that, when executed by the processor, are configurable to cause the computer system to:
generate a first recommendation model that includes a source domain, wherein the first recommendation model includes a first context module that is based on a set of context variables to represent an interaction context between a first set of users, a first set of entities, and the set of context variables;
extract a meta-model from the first recommendation model;
generate a second recommendation model based on the meta-model;
transfer, based on the set of context variables, the first context module to a second context module of the second recommendation model for a target domain;
generate a transfer learning model based on the first recommendation model and the second recommendation model;
generate a set of recommendations based on the transfer learning model; and
encode a message for transmission to a computing device of a user associated with the second recommendation model that includes the set of recommendations.

2. The system of claim 1, wherein the source domain is a dense-data domain and the target domain is a sparse-data domain.

3. The system of claim 2, wherein the set of context variables in the first context module are associated with a first set of transaction records associated with a dense-data source domain, and the second context module is based on a second set of transaction records associated with the sparse-data target domain.

4. The system of claim 3, wherein the context variables for the first context module or the second context module include: an interactional context variable associated with a condition under which a transaction associated with a user occurs.

5. The system of claim 3, wherein the context variables for the first context module or the second context module include: a historical context variable associated with a past transaction associated with a user.

6. The system of claim 3, wherein the context variables for the first context module or the second context module include: an attributional context variable associated with a time-invariant attribute associated with a user.

7. The system of claim 2, wherein the first recommendation model further includes a first user embedding module that is to index an embedding of the first set of users within the dense-data source domain, and the second recommendation model includes a second user embedding module that is to index an embedding of a second set of users within the sparse-data target domain.

8. The system of claim 7, wherein transferring the first context module to the second context module does not include transferring the first user embedding module to the second user embedding module.

9. The system of claim 2, wherein the first recommendation model further includes a first entity embedding module that is to index an embedding of the first set of entities within the dense-data source domain, and the second recommendation model includes a second entity embedding module that is to index an embedding of a second set of entities within the sparse-data target domain.

10. The system of claim 9, wherein transferring the first context module to the second context module does not include transferring the first entity embedding module to the second entity embedding module.

11. The system of claim 2, wherein the first recommendation model further includes a first user context-conditioned clustering module that is to generate clusters of the first set of users within the dense-data source domain, and the second recommendation model includes a second user context-conditioned clustering module that is to generate clusters of a second set of users within the sparse-data target domain.

12. The system of claim 11, wherein transferring the first context module to the second context module does not include transferring the first user context-conditioned clustering module to the second user context-conditioned clustering module.

13. The system of claim 11, wherein the first recommendation model further includes a first entity context-conditioned clustering module that is to generate clusters of the first set of entities within the dense-data source domain, and the second recommendation model includes a second entity context-conditioned clustering module that is to generate clusters of a second set of entities within the sparse-data target domain.

14. The system of claim 13, wherein transferring the first context module to the second context module does not include transferring the first entity context-conditioned clustering module to the second entity context-conditioned clustering module.

15. The system of claim 13, wherein the first recommendation model further includes a first mapping module that is to map the clusters of the first set of users and the first set of entities, and the second recommendation model includes a second mapping module that is to map the clusters of the second set of users and the second set of entities.

16. The system of claim 1, wherein the set of recommendations includes a subset of the first set of entities recommended for a user from first set of users.

17. The system of claim 1, wherein the first context module and the second context module share one or more context transformation layers.

18. The system of claim 1, wherein the instructions are further to cause the computer system to:
generate a collaborative filtering model based on a randomized sequence of user interactions associated with a third set of entities, wherein the third set of entities includes an entity not present in the first set of entities or a second set of entities associated with the second recommendation model; and
generate a popularity model based on a total number of transactions associated with each entity from the first set of entities, second set of entities, and third set of entities, wherein the set of recommendations are further generated based on the collaborative filtering model and the popularity model.

19. A tangible, non-transitory computer-readable medium storing instructions that, when executed by a computer system, are configurable to cause the computer system to:
generate a first recommendation model that includes a source domain, wherein the first recommendation model includes a first context module that is based on a set of context variables to represent an interaction context between a first set of users, a first set of entities, and the set of context variables;
extract a meta-model from the first recommendation model;
generate a second recommendation model based on the meta-model;
transfer, based on the set of context variables, the first context module to a second context module of the second recommendation model for a target domain;
generate a transfer learning model based on the first recommendation model and the second recommendation model;
generate a set of recommendations based on the transfer learning model; and
encode a message for transmission to a computing device of a user associated with the second recommendation model that includes the set of recommendations.

20. A computer-implemented method comprising:
generating a first recommendation model associated with a dense-data source domain, wherein the first recommendation model includes: (i) a first context module that is based on a set of context variables associated with set of transaction records for the dense-data source domain; (ii) a first user embedding module that is to index an embedding of a first set of users within the dense-data source domain; and (iii) a first merchant embedding module that is to index an embedding of a first set of merchants within the dense-data source domain;
extracting a meta-model from the first recommendation model;
generating, based on the meta-model, a second recommendation model associated with a sparse-data target domain;
transferring the first context module to a second context module of the second recommendation model based on the set of context variables;
generating a transfer learning model based on the first recommendation model and the second recommendation model;
generating a set of recommendations based on the transfer learning model; and
encoding a message for transmission to a computing device of a user associated with the second recommendation model that includes the set of recommendations.
